(19) United States
(12) Patent Application Publication
(10) Pub. No.: US 2024/0289777 A1
(43) Pub. Date: Aug. 29, 2024

(54) DIGITAL ASSET TRANSFER SYSTEMS AND METHODS

(71) Applicant: State Farm Mutual Automobile Insurance Company, Bloomington, IL (US)

(72) Inventors: Aaron Williams, Congerville, IL (US); Seth L. Corin, Cumming, GA (US)

(21) Appl. No.: 18/540,576

(22) Filed: Dec. 14, 2023

Related U.S. Application Data
(60) Provisional application No. 63/596,853, filed on Nov. 7, 2023.
(60) Provisional application No. 63/507,579, filed on Jun. 12, 2023.
(60) Provisional application No. 63/486,890, filed on Feb. 24, 2023.

(51) Int. Cl. G06Q 20/36

(52) U.S. Cl. CPC G06Q 20/3678

(57) ABSTRACT

A digital asset (DA) computing system may include a memory and a processor. The processor may be programmed to receive a plurality of digital assets associated with an electronic record of a user, store the plurality of digital assets, and receive a request to check out at least one digital asset of the plurality of digital assets. The processor may also be programmed to cause a transfer of the at least one digital asset from the electronic record to the electronic target location, record the transfer in an electronic ledger, receive the at least one digital asset from the electronic target location, store the at least one digital asset back in the electronic record, and store receipt of the at least one digital asset in the electronic ledger.

### CROSS REFERENCE TO RELATED APPLICATIONS

This application claims the benefit of priority to U.S. Provisional Patent Application No. 63/596,853, filed Nov. 7, 2023, U.S. Provisional Patent Application No. 63/507,579, filed Jun. 12, 2023, and U.S. Provisional Patent Application No. 63/486,890, filed Feb. 24, 2023, the contents and disclosures of which are hereby incorporated by reference herein in their entireties.

### FIELD OF DISCLOSURE

The present disclosure relates to securely storing digital assets and, more particularly, to computer-based systems and methods for securely storing digital assets within a centralized memory and/or conveniently transferring the digital assets.

### BACKGROUND

In today's world, there are many different types of digital assets. For example, digital assets may include digital creations used on the web, web3, and/or the metaverse. Other digital assets may include different computer platforms, applications, and/or access points used by a user along with the different passwords needed to access these platforms. Other digital assets may include online bank accounts, cryptocurrency, funds, digital contracts, and/or non-fungible tokens (NFTs).

These digital assets may be saved or listed in a variety of locations throughout the web. They may not be easily tracked or maintained by a user. In some cases where someone other than the owner needs to access these digital assets, it may not be easily done. For example, in the case where the owner of the digital assets becomes deceased, a family member or representative of the owner may be required to access these digital assets and eventually transfer them to others.

In addition, there are other situations in which assessing and evaluating a digital asset's history may be useful or necessary. For example, when selling, purchasing, transferring, leasing, and/or insuring a digital asset, it may be beneficial to have an accurate and complete history of the digital asset in order to provide an accurate assessment or evaluation of that digital asset. However, in many instances, a digital asset's known history may be limited, and may frequently be out of date. In further instances, certain aspects of a digital asset's history may be difficult to discern and/or monitor. Conventional techniques for transferring digital assets may include other inefficiencies, encumbrances, ineffectiveness, and/or drawbacks as well.

### BRIEF SUMMARY

The present embodiments may relate to a computer system for automatic transfer of digital assets across electronic or digital assets and/or automatically tracking and storing history regarding digital assets in electronic ledgers. The computer system, as described herein, may include a digital asset (DA) computing device that is in communication with a plurality of data sources, user devices, and/or third-party devices.

In one aspect, a DA computing system may be provided. The system, and/or any of the systems described herein, may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, a DA computing system may include at least one memory and at least one processor in communication with the at least one memory. The processor may be programmed to: (1) receive a plurality of identifiers for identifying a plurality of digital assets associated with a first electronic record, each identifier of the plurality of identifiers configured to identify a digital asset and/or grant access to the digital asset; (2) store the plurality of identifiers as being associated with the first electronic record; (3) receive an input associated with at least one digital asset of the plurality of digital assets wherein the input includes a transfer identifier instruction, the transfer identifier instruction configured to cause the identifier associated with the at least one digital asset to be transferred from the first electronic record to a second electronic record; (4) identify that a trigger condition has occurred; and/or (5) in response to the trigger condition, execute the transfer identifier instruction to automatically cause the identifier associated with the at least one digital asset to be transferred from the first electronic record to the second electronic record based upon the transfer identifier such that the second electronic record has access rights to the digital asset. The DA computing system may include additional, less, or alternate functionality including that discussed elsewhere herein.

In another aspect, at least one non-transitory computer-readable storage medium with instructions stored thereon may be provided. Execution of the instructions may be implemented by one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the instructions may be executed by at least one processor wherein execution of the instructions may cause the at least one processor to: (1) receive a plurality of identifiers for identifying a plurality of digital assets associated with a first electronic record, each identifier of the plurality of identifiers configured to identify a digital asset and/or grant access to the digital asset; (2) store the plurality of identifiers as being associated with the first electronic record; (3) receive an input associated with at least one digital asset of the plurality of digital assets wherein the input includes a transfer identifier instruction, the transfer identifier instruction configured to cause the identifier associated with the at least one digital asset to be transferred from the first electronic record to a second electronic record; (4) identify that a trigger condition has occurred; and/or (5) in response to the trigger condition, execute the transfer identifier instruction to automatically cause the identifier associated with the at least one digital asset to be transferred from the first electronic record to the second electronic record based upon the transfer identifier such that the second electronic record has access rights to the digital asset. The at least one non-transitory computer-readable storage medium may include additional, less, or alternate functionality including that discussed elsewhere herein.

In another aspect, a computer-implemented method implemented may be provided. The computer-implemented method, and the other methods described herein, may be implemented by one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the method may be implemented by at least one processor in communication with at least one memory. The computer-implemented method may include: (1) receiving a plurality of identifiers for identifying a plurality of digital assets associated with a first electronic record, each identifier of the plurality of identifiers configured to identify a digital asset and/or grant access to the digital asset; (2) storing the plurality of identifiers as being associated with the first electronic record; (3) receiving an input associated with at least one digital asset of the plurality of digital assets wherein the input includes a transfer identifier instruction, the transfer identifier instruction configured to cause the identifier associated with the at least one digital asset to be transferred from the first electronic record to a second electronic record; (4) identifying that a trigger condition has occurred; and/or (5) in response to the trigger condition, executing the transfer identifier instruction to automatically cause the identifier associated with the at least one digital asset to be transferred from the first electronic record to the second electronic record based upon the transfer identifier such that the second electronic record has access rights to the digital asset. The computer-implemented method may include additional, less, or alternate functionality, including that discussed elsewhere herein.

In another aspect, a DA computing system including at least one memory and at least one processor in communication with the at least one memory may be provided. The processor may be programmed to: (1) receive a plurality of digital assets associated with an electronic record of a user; (2) store the plurality of digital assets as being associated with the electronic record; (3) receive a request to check out at least one digital asset of the plurality of digital assets wherein the request includes an electronic target location for the at least one digital asset while the at least one digital asset is checked out; (4) cause a transfer of the at least one digital asset from the electronic record to the electronic target location; (5) record the transfer in an electronic ledger; (6) receive the at least one digital asset from the electronic target location; (7) store the at least one digital asset back in the electronic record; and/or (8) store receipt of the at least one digital asset in the electronic ledger. The DA computing system may include additional, less, or alternate functionality including that discussed elsewhere herein.

In another aspect, at least one non-transitory computer-readable storage medium with instructions stored thereon may be provided. Execution of the instructions may be implemented by one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the instructions may be executed by at least one processor wherein execution of the instructions may cause the at least one processor to: (1) receive a plurality of digital assets associated with an electronic record of a user; (2) store the plurality of digital assets as being associated with the electronic record; (3) receive a request to check out at least one digital asset of the plurality of digital assets wherein the request includes an electronic target location for the at least one digital asset while the at least one digital asset is checked out; (4) cause a transfer of the at least one digital asset from the electronic record to the electronic target location; (5) record the transfer in an electronic ledger; (6) receive the at least one digital asset from the electronic target location; (7) store the at least one digital asset back in the electronic record; and/or (8) store receipt of the at least one digital asset in the electronic ledger. The at least one non-transitory computer-readable storage medium may include additional, less, or alternate functionality including that discussed elsewhere herein.

In another aspect, a computer-implemented method implemented by at least one processor in communication with at least one memory may be provided. The computer-implemented method may include: (1) receiving a plurality of digital assets associated with an electronic record of a user; (2) storing the plurality of digital assets as being associated with the electronic record; (3) receiving a request to check out at least one digital asset of the plurality of digital assets wherein the request includes an electronic target location for the at least one digital asset while the at least one digital asset is checked out; (4) causing a transfer of the at least one digital asset from the electronic record to the electronic target location; (5) recording the transfer in an electronic ledger; (6) receiving the at least one digital asset from the electronic target location; (7) storing the at least one digital asset back in the electronic record; and/or (8) storing receipt of the at least one digital asset in the electronic ledger. The computer-implemented method may include additional, less, or alternate functionality, including that discussed elsewhere herein.

In another aspect, a DA computing system including at least one memory and at least one processor in communication with the at least one memory may be provided. The processor may be programmed to: (1) identify a plurality of digital assets stored in the at least one memory for administration by a distributor; (2) identify a plurality of potential receivers for the plurality of digital assets; (3) cause display of a plurality of selectors wherein each selector is associated with at least one digital asset of the plurality of digital assets; (4) cause display of a plurality of display areas wherein each display area is associated with at least one potential receiver of the plurality of potential receivers; (5) receive an input associated with a selector of the plurality of selectors and a receiver of the plurality of potential receivers; (6) cause display of the selector in the display area associated with the receiver; and/or (7) cause the at least one digital asset associated with the selector to be transferred to a digital record associated with the receiver. The DA computing system may include additional, less, or alternate functionality including that discussed elsewhere herein.

In another aspect, at least one non-transitory computer-readable storage medium with instructions stored thereon may be provided. Execution of the instructions may be implemented by one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the instructions may be executed by at least one processor wherein execution of the instructions may cause the at least one processor to: (1) identify a plurality of digital assets stored in the at least one memory for administration by a distributor; (2) identify a plurality of potential receivers for the plurality of digital assets; (3) cause display of a plurality of selectors wherein each selector is associated with at least one digital asset of the plurality of digital assets; (4) cause display of a plurality of display areas wherein each display area is associated with at least one potential receiver of the plurality of potential receivers; (5) receive an input associated with a selector of the plurality of selectors and a receiver of the plurality of potential receivers; (6) cause display of the selector in the display area associated with the receiver; and/or (7) cause the at least one digital asset associated with the selector to be transferred to a digital record associated with the receiver. The at least one non-transitory computer-readable storage medium may include additional, less, or alternate functionality including that discussed elsewhere herein.

In another aspect, a computer-implemented method implemented by at least one processor in communication with at least one memory may be provided. The computer-implemented method may include: (1) identifying a plurality of digital assets stored in the at least one memory for administration by a distributor; (2) identifying a plurality of potential receivers for the plurality of digital assets; (3) causing display of a plurality of selectors wherein each selector is associated with at least one digital asset of the plurality of digital assets; (4) causing display of a plurality of display areas wherein each display area is associated with at least one potential receiver of the plurality of potential receivers; (5) receiving an input associated with a selector of the plurality of selectors and a receiver of the plurality of potential receivers; (6) causing display of the selector in the display area associated with the receiver; and/or (7) causing the at least one digital asset associated with the selector to be transferred to a digital record associated with the receiver. The computer-implemented method may include additional, less, or alternate functionality, including that discussed elsewhere herein.

In another aspect, a DA computing system including at least one memory and at least one processor in communication with the at least one memory may be provided. The processor may be programmed to: (1) in response to a trigger condition, automatically identify that access to at least one identifier should be transferred from a digital record associated with a user to a different digital record associated with a different user wherein the at least one identifier is configured to identify at least one digital asset and great access to the at least one digital asset; (2) determine that no digital record has been created for the different user in the DA computing system; (3) cause a notification to be transmitted to a user computing device associated with the different user wherein the notification includes a message indicating that the user is eligible to receive the at least one identifier; (4) in response to an input at the user computing device, create the different digital record associated with the different user; and/or (5) cause the at least one identifier to be transferred from the digital record to the different digital record. The DA computing system may include additional, less, or alternate functionality including that discussed elsewhere herein.

In another aspect, at least one non-transitory computer-readable storage medium with instructions stored thereon may be provided. Execution of the instructions may be implemented by one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the instructions may be executed by at least one processor wherein execution of the instructions may cause the at least one processor to: (1) in response to a trigger condition, automatically identify that access to at least one identifier should be transferred from a digital record associated with a user to a different digital record associated with a different user wherein the at least one identifier is configured to identify at least one digital asset and great access to the at least one digital asset; (2) determine that no digital record has been created for the different user in the DA computing system; (3) cause a notification to be transmitted to a user computing device associated with the different user wherein the notification includes a message indicating that the user is eligible to receive the at least one identifier; (4) in response to an input at the user computing device, create the different digital record associated with the different user; and/or (5) cause the at least one identifier to be transferred from the digital record to the different digital record. The at least one non-transitory computer-readable storage medium may include additional, less, or alternate functionality including that discussed elsewhere herein.

In another aspect, a computer-implemented method implemented by at least one processor in communication with at least one memory may be provided. The computer-implemented method may include: (1) in response to a trigger condition, automatically identifying that access to at least one identifier should be transferred from a digital record associated with a user to a different digital record associated with a different user wherein the at least one identifier is configured to identify at least one digital asset and great access to the at least one digital asset; (2) determining that no digital record has been created for the different user; (3) causing a notification to be transmitted to a user computing device associated with the different user wherein the notification includes a message indicating that the user is eligible to receive the at least one identifier; (4) in response to an input at the user computing device, creating the different digital record associated with the different user; and/or (5) causing the at least one identifier to be transferred from the digital record to the different digital record. The computer-implemented method may include additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates an exemplary digital asset (DA) computing system;

FIG. 2 illustrates an exemplary data flow diagram for digital asset transfer using the DA computing system shown in FIG. 1;

FIG. 3 illustrates another exemplary data flow diagram for digital asset transfer using the DA computing system shown in FIG. 1;

FIG. 4 illustrates an exemplary configuration of a user computer device, in accordance with one embodiment of the present disclosure;

FIG. 5 illustrates an exemplary configuration of a host computing device, in accordance with one embodiment of the present disclosure;

FIG. 6 illustrates an exemplary computer-implemented process for digital asset transfer using the DA computing system shown in FIG. 1;

FIG. 7 illustrates another exemplary computer-implemented process for digital asset transfer using the DA computing system shown in FIG. 1;

FIG. 8 illustrates another exemplary computer-implemented process for digital asset transfer using the DA computing system shown in FIG. 1; and

FIG. 9 illustrates another exemplary computer-implemented process for digital asset transfer using the DA computing system shown in FIG. 1.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, digital asset transfer systems and methods. A computer system (e.g., DA computing system), as described herein, may include a digital asset (DA) computing device that is in communication with a plurality of data sources, user devices, and/or third-party devices.

The description provided herein includes certain examples and exemplary use cases. It should be understood that these examples and use cases are included herein for illustrative purposes, and these examples and use cases should not be taken to limit the present disclosure. The systems and methods described herein may be used in many other use cases.

Consumers and/or businesses may have a multitude of digital assets created for the future of the web, web3, and the metaverse. Consumers and/or businesses may also have a multitude of computer platforms, applications, and network access points that they utilize along with a variety of passwords used to access these platforms, applications and access points. These may all be considered digital assets that may be created, stored, secured, protected, and/or transferable using the system described herein. These digital assets may also include online accessible funds (e.g., online bank accounts), digital contracts, legal documents (e.g., last will and testament), cryptocurrency, and/or non-fungible tokens (NFTs).

In the example embodiment, a digital asset vault may be configured to store any digital assets (e.g., and/or identifiers for accessing digital assets) for users such that all digital assets associated with those users are securely stored in a central location. In the example embodiment, digital assets may include social media accounts, digital brands, digital identities, cryptocurrency accounts, metaverse digital assets and/or avatars, digital art and/or design, NFTs, NFT vaults, passwords and/or access codes for all digital assets such as crypto, email, social media, and/or other accounts, digital contracts, digital deeds, digital records, digital certificates, bank, investment, and/or digital financial accounts, digital family documents, digital historical documents, and/or digital biological assets.

For instance, a user may store all desired digital assets and/or identifiers for accessing digital assets (e.g., account information such as usernames and/or passwords) in the digital vault for accessing and/or using those digital assets and/or transferring those digital assets (e.g., to another user upon a sale, in to and/or out of a virtual environment). The digital vault may reside as a database on a cloud-based system. During asset transfers, the system may use application program interfaces (APIs) to connect out to other defined and permission granted sources. Movement of the digital assets may include a user uploading a digital asset and making one or more defined access assignments. The defined assignments may dictate access permissions and other rights for accessing the asset for one or more persons. For example, an executor or an heir may import or otherwise designate accounts to and from which the digital asset may be moved. In one specific example, an owner may add digital assets that include a savings account, a trading investment account, and an account that includes a record of art or other possessions. At or prior to the time of testate succession, the at least one processor of the computing system may execute instructions to automatically add multiple heirs to one or more of the three accounts. From there, an executor of the estate may electronically transfer the digital assets from the decedent to the heir using, for instance, a drag and drop function with an interface designating what and how much is to be distributed. A record of all transactions is made showing that the inheritance has been distributed according to the trust or will.

As some examples, certain digital assets, such as digital contracts, digital art, and/or digital family and historical assets may be stored in the vault themselves as associated with a specific record (e.g., a user account), while other digital assets, such as cryptocurrencies and/or other funds, may be stored elsewhere but identifiers associated with accessing those digital assets may be stored in the vault (e.g., so that someone with access to the digital record may easily access the associated digital asset(s)).

Further, users may define transfer instructions for their digital assets so that when a user becomes deceased, the DA computing system may cause those digital assets to be transferred (e.g., to other records and/or accounts within the vault) based upon the transfer instructions. In other words, the DA computing system may provide automatic executor services. For example, a smart trigger (e.g., associated with a smart contract) may be triggered upon a trigger condition (e.g., proof of death regarding a user provided to the DA computing system) such that digital assets associated with the smart trigger are automatically transferred from one electronic record to another (e.g., with the transfers being recorded in an electronic ledger).

Embodiments of the present system may also include security features to support such automatic transfers of digital assets. For instance, access and execution of the digital assets may include a two or three factor identification operation. In one implementation, each trigger occurrence may cause each of the defined beneficiaries to receive a communication instructing them how to access that portion of a digital asset to which they have rights. In one particular example where a digital asset includes a will or trust, the authenticity of a receiver may require the uploading of images of government documents, such as a social security card, a driver's license, or a birth certificate. The document images may ultimately be analyzed and authenticated by a human or by artificial intelligence (AI) techniques. Continuing with the above example, an owner of the will may require heirs to upload and maintain current copies of the government documents. Annual electronic mail reminders could be sent to heirs to ensure their information is correct or needs to be updated. In the case of a child, program code, when executed by the at least processor, may cause a prompt to be displayed on a parent's computing device to validate the information of the child to be used for authentication.

In some embodiments, the DA computing system may provide a user interface for automatic transfer of digital assets as controlled by an executor (e.g., the executor may “drag and drop” selectors associated with digital assets (e.g., and or amounts of assets, such as dollar amounts) to display areas associated with other digital records, resulting in the DA computing system securely transferring the digital assets to the respective other digital records).

For example, an executor may “drag” an icon of a digital asset to a display area associated with a first heir and drag another icon of another digital asset to a second display area associated with a second heir. When all digital assets are associated with an heir, a one button click (e.g., input by the executor) may cause the digital assets to be distributed to the individual heirs. In some embodiments, within a message sent to the heirs, the heirs may be notified to accept an agreement associated with the digital assets. In some embodiments, the agreement may be associated with creating an account for one or more of the heirs in DA computing system 100 to receive the respective digital assets (e.g., with DA computing device 102 automatically transferring the respective digital assets to the new account and/or record).

Actions involving the drag and drop function described above may automatically become part of the stored digital asset history. For instance, a pie chart may be automatically generated to include a visual representation of slices of an asset received by each heir. In another example, undeclared assets (e.g., digital assets that were not part of the will) could be dragged and dropped to different recipients. This visual representation may provide an executor and heirs with a literal picture of how assets are distributed. The underlying transactions of the visual display would be used to create a record of items transferred or received to individual heirs. Other graphical displays may highlight potential losses of value, and/or potential discrepancies.

The visual displays, such as graphs and charts, of the user interface may include analysis that has been automatically generated and output to visually communicate changes to the status of a digital asset. Other visual displays may reflect a change in asset value. For instance, a graph may depict investment, growth, trends, or overall value, among other trackable metrics. The analysis may offer insights to help people manage their assets. Graphical data may additionally inform heirs on investment options and potential tax consequences.

Transactions and/or transfers (e.g., proof of transaction and/or transfer, date, amount, etc.) associated with digital assets stored in the vault may be automatically recorded in a secure ledger (e.g., a blockchain ledger) so that histories associated with digital assets are securely tracked and/or stored. The secure storage of digital asset histories further improves digital asset transfer.

In one example embodiment, the system may be configured to automatically analyze the digital asset histories stored within the system for potential discrepancies and to otherwise confirm digital assets were accurately distributed. For instance, the system may store and access a defined list of which assets should be transferred from a decedent to an heir. The system memory may further store a digital record of all assets that have been input. Another or the same digital record may account for all output of the assets to the heir(s). Thus, the automated processes may compare the record of assets input to those assets being output and may cross reference the defined list of willed distributions. Thus, the system intelligently confirms or validates that all assets stored within the system are properly distributed.

Smart contracts may also be utilized in other transfers of digital assets implemented by the DA computing system such as the purchase and/or sale of digital assets. In some embodiments, the DA computing system may automatically transfer funds associated with a transaction to and/or from an appropriate bank account (e.g., via one or more application programming interfaces (APIs)).

For example, when an owner of digital assets is alive, organizing and transferring digital assets across platforms may be difficult because the infrastructure for seamlessly storing, managing, and transferring large amounts of digital assets is not available. Further, infrastructure for transferring funds from a sale or purchase of digital assets may be available, but not conveniently within one centralized location (e.g., in the same location as where digital assets are stored, as described in some embodiments herein).

Additionally, known processes for managing a decedent's digital accounts and assets as an executor may include barriers, gaps, and pain points. For example, accessing multiple social media and other accounts and platforms where digital assets may be stored, locating local digital assets on personal drives, locating passwords or codes to access those assets, and then centralizing all digital assets for the purpose of distributing to heirs per a will, trust, or other legal document or order, are time-consuming and burdensome processes.

In the example embodiment described herein, digital assets may be securely transferred by an owner while the owner is alive and/or an executor after death of the owner to a digital asset vault via a secure digital asset portal. The stored digital assets may be transferred to a new owner via sale or to heirs after death and/or be transferred to another location such as the metaverse and/or web3 for use by the owner. Digital assets may also be imported from a purchase of a digital asset or from the owner's creation of a new digital asset.

Further, the owner may have the option to automatically transfer all digital assets per their wishes upon their death. Additionally, a service provider (e.g., associated with the DA computing device) may become the listed executor that may manage and/or transfer an owner's digital assets per the wishes of a trust, will, legal document, or order. In other words, the DA computing device may operate as an executor (e.g., as a service product and/or an executor as a service).

In some embodiments, heirs may receive inherited digital assets and have the opportunity to open their own record (e.g., account) in the digital asset vault, import inherited assets, and/or continue to store digital assets within the vault.

In some embodiments, the DA computer system may receive a plurality of identifiers (e.g., the digital assets themselves and/or data for accessing the digital assets, such as usernames, passwords, etc.) for accessing a plurality of digital assets associated with an electronic record (e.g., user account) and store the plurality of identifiers as being associated with the electronic record. The DA computing system may then receive an input associated with at least one digital asset of the plurality of digital assets wherein the input includes a transfer identifier (e.g., a transfer identifier instruction associated with the at least one digital asset, an electronic record from which the at least one digital asset will be transferred from, and/or an electronic record to which the at least one digital asset will be transferred) associated with the current electronic record and a different electronic record.

The DA computer system may further identify that a trigger condition has occurred (e.g., receive proof of death data regarding a user associated with the electronic record) and, in response to the trigger condition, automatically cause at least one identifier of the plurality of identifiers associated with the at least one digital asset to be transferred from the current digital record to the different digital record based upon the transfer identifier such that the different digital record has access to the at least one digital asset. As explained below, this automatic transfer may be initiated or prompted through the use of a smart contract stored within the DA computing system.

In some embodiments, digital assets may not be associated with a transfer identifier. Accordingly, the digital assets not associated with a transfer identifier may be saved as being associated with an executor account of an executor. In the example embodiment, the transfer identifier may be a transfer identifier instruction associated with at least one digital asset, an electronic record from which the at least one digital asset will be transferred from, an electronic record to which the at least one digital asset will be transferred, and/or a trigger condition upon which the transfer should occur.

In some embodiments, the DA computer system may be configured to receive a plurality of digital assets associated with an electronic record of a user and/or store the plurality of digital assets as being associated with the electronic record. The DA computer system may then receive a request to check out at least one digital asset of the plurality of digital assets wherein the request includes an electronic location for the at least one digital asset while the at least one digital asset is checked out, cause a transfer of the at least one digital asset to the digital location, and/or record the transfer in an electronic ledger (e.g., a blockchain ledger). The DA computer system may also receive the at least one digital asset from the digital location, store the at least one digital asset, and/or store receipt of the at least one digital asset in the electronic ledger.

In some embodiments, the DA computer system may be configured to identify a plurality of digital assets stored in at least one memory for administration by a distributor (e.g., an executor), identify a plurality of potential receivers (e.g., heirs) for the plurality of digital assets, cause display of a plurality of selectors wherein each selector is associated with at least one digital asset of the plurality of digital assets, and/or cause display of display areas, wherein each display area is associated with at least one potential receiver of the plurality of potential receivers. The DA computer system may also receive an input associated with a selector of the plurality of selectors and a receiver of the plurality of potential receivers, cause display of the selector in the display area associated with the receiver, and/or cause the at least one digital asset associated with the selector to be transferred to a digital record associated with the receiver.

In some embodiments, the DA computer system may further receive a sale input associated with a sale of a digital asset of the plurality of digital assets, cause the digital asset to be transferred to a purchaser digital record associated with a purchaser of the sale, receive funds associated with the sale, and/or store the funds in the plurality of digital assets for administration by the executor. The ownership history of the asset then may be updated in a block of an associated blockchain.

In some embodiments, the DA computer system may be configured to, in response to a trigger condition, automatically identify that access to at least one identifier for accessing at least one digital asset should be transferred from a digital record associated with a user to a different digital record associated with a different user, determine that no digital record has been created for the different user in the computer system, and/or cause a notification to be transmitted to a user computing device associated with the different user wherein the notification includes a message indicating that the user is eligible to receive the at least one identifier for accessing the at least one digital asset. The DA computer system may further be configured to, in response to an input at the user computing device, create the different digital record associated with the different user and/or cause the at least one identifier associated with the at least one digital asset to be transferred from the digital record to the different digital record. In some embodiments, any transfer of digital assets, as described herein, may be performed by the user of one or more smart contracts in and/or associated with the DA computer system.

In some embodiments, the DA computer system may further receive a second input associated with another at least one digital asset wherein the another at least one digital asset was not previously associated with the digital record and/or cause another at least one identifier for accessing the another at least one digital asset to be stored in the different digital record.

In some embodiments, the DA computing device may securely store asset histories and assessments in container files that are accessible via cloud-based networks and devices, for improved accessibility.

As used herein, “assets” and/or “digital assets” may include social media, digital brand identity, cryptocurrency, metaverse digital assets/avatars/designs, digital art and designs, NFTs and NFT vaults, passwords and/or codes for digital assets, contracts, deeds, records and certificates, financial accounts, historical and/or family documents and/or records. In some embodiments, assets may include personal property, vehicles, homes, and/or other buildings. In at least some embodiments, “assets” may broadly encompass any item or property that would be assessed during the purchase, sale, or insuring of the item. In the exemplary embodiment of the present disclosure, an asset history is developed by collecting (e.g., receiving, retrieving, etc.) data associated with the asset from a plurality of sources. These sources may include reference sources, such as insurance data sources, governmental data sources, and/or financial institutions. These reference sources may store data that is considered verified and/or validated, although this data may be static or relatively static (e.g., tax information, credit history, previous sale data, payment history, etc.). The data sources may advantageously also include a plurality of sensors, which may provide more recent, current, updated, and/or real-time data associated with the asset. The sensors may be vehicle sensors, device sensors (e.g., sensors within a user computing device operated by a user), home sensors, sensors within smart devices (e.g., “internet of things” devices), and the like.

In some instances, the DA computing device may generate a first or initial asset history for the asset based upon the data from the reference sources. The DA computing device may thereafter update or replace the initial asset history with additional data—such as data from the plurality of sensors—to generate an updated asset history. The updated asset history may be referred to as a “real-time” or “current” asset history, in some exemplary embodiments, because this updated asset history may include the most recent available data associated with the asset (e.g., data retrieved and assessed within seconds, minutes, or hours of being sensed and/or captured). The DA computing device may update the asset history thereafter using any newly received data. In some embodiments, the DA computing device continuously updates the asset history, such as periodically (e.g., daily, weekly, monthly, quarterly, etc.) or in response to receiving new or updated data associated with an asset. In other embodiments, the DA computing device generates the updated asset history in response to a specific request. For example, a user may request an updated asset history because the user is purchasing an asset, selling an asset, insuring an asset, etc.

In the exemplary embodiment, the DA computing device may store the asset history/histories as a container file in an electronic ledger (e.g., a blockchain ledger), to securely contain the information. The DA computing device may generate an NFT for the asset based upon the data stored in the container file. The DA computing device may allow subsequent access to the NFT by verified or authorized parties-such as a user associated with the asset, purchasing the asset, selling the asset, insuring the asset, etc. When new or updated information is received and/or incorporated into the container file, the DA computing device may generate an updated NFT to represent the updated asset history. The updated NFT may be a completely new token, replacing any pre-existing token (while including a hash value of the previous token) and/or may be an updated version of the pre-existing token, with a hash including an update history of the container file and/or NFT.

As used herein, an NFT (non-fungible token) is a digital asset that represents another object, such as, but not limited to, a real-world object and/or a digital object. The NFT may be generally stored in a blockchain or other cryptographic ledger or register. The NFT may include, but is not limited to, ownership information and a link to a digital asset file that describes, points to, or otherwise indicates a real-world or digital object (or in some cases the NFT may actually include the data associated with the digital asset or real-world asset). NFTs may be traded, sold, exchanged, or otherwise change ownership. The ownership change may be stored on the corresponding blockchain, ledger, and/or register.

A blockchain may be a distributed database that maintains a continuously growing list of ordered records, known as blocks. Each block may contain at least a timestamp and a link to the previous block in the chain. The link to the previous block may be a hash of the previous block. For an insurance contract, the first block may contain the initial contract between a driver and an insurer. The second block may contain a modification to the contract that was requested by the driver and approved by the insurer. The second block may contain a hashed copy of the first block as well. The third block may contain one or more additional terms for the insurance contract and a hashed copy of the second block. This continues on with each block adding on to the next while containing a hash of the previous blocks in the blockchain.

To ensure the security of the information contained in the blockchain, copies of the blockchain may be distributed across multiple computer devices, known as nodes. These nodes maintain the blockchain, update the blockchain when changes occur, and ensure the stability of the blockchain itself. In some embodiments, nodes may be also used to calculate the hash of the previous blocks. As the blockchain grows, the processing power needed to calculate the hash of the previous blocks grows as well. In these embodiments, the processing of the hash may be distributed over multiple computer devices to improve the speed of processing and/or to not overburden the hashing processor. When a node processes (hashes) a block, that node is known as a miner, where the action of validating and hashing the block is also known as mining.

Other electronic ledger infrastructure may be employed, which may include blockchains or other similar technology. More broadly, the term “container file,” as used herein, may refer to a block in a blockchain, or to any other recorded instance in an immutable electronic ledger.

In at least one embodiment, the NFT entry on the blockchain includes the location of the NFT and a hash of the NFT. This hash allows the DA computing device and/or any users to ensure that the NFT has not been modified. In these embodiments, when data is added to the NFT, then the NFT is re-hashed, and that hash is provided in a new block on the blockchain. For example, the DA computing device may receive updated ownership information from a third-party server, and/or updated sensor information from a vehicle or user computing device. The DA computing device retrieves the location of the NFT and the hash for the NFT from the blockchain. The DA computing device compares the hash to the NFT to validate the NFT. In at least one embodiment, the DA computing device hashes the NFT and compares that hash to the stored hash. If they match, then the NFT is validated. The DA computing device modifies the NFT to include the report and then creates a hash of the NFT including the report. The new hash is reported to and stored in a new block on the blockchain.

As used herein, “VR environment” (e.g., virtual reality environment) refers to a digital or virtual environment experienced by or displayed to a user through a VR computing device. In other words, “VR environment” refers to the VR view and functionality experienced by a user through a VR enabled computing device. Conversely, any virtual or digital environment displayed to a user through a VR computing device may be considered a VR environment.

As used herein, “AR environment” (e.g., augmented reality environment) refers to a digital or virtual environment overlaid on a real-world environment and experienced by a user through a VR/AR computing device. In other words, “AR environment” refers to the AR display and functionality experienced by a user through an AR enabled computing device.

In some further embodiment, the VR and/or AR may allow for haptic responses to allow the user to feel an interaction with an object. The haptic response may be provided through the use of gloves or other feedback devices. In one embodiment, the haptic response allows the user to feel the texture of the 3-D object and/or the weight of the 3-D object. For example, the user may shake an avatar's hand or receive a virtual object from the avatar, and the user would be able to feel the handshake and/or the object being handed to the avatar.

At least one of the technical problems addressed by this system may include: (i) securely generating asset histories in a ledger (e.g., a blockchain ledger); (ii) providing the ability for digital assets to be securely transferred out from and/or in to a digital asset vault (e.g., in transactions and/or for use in virtual environments); (iii) updating digital asset histories to maintain currency of records; (iv) improving speed and efficiency of digital asset transfer (e.g., upon death as an automatic executor service); (v) improving accuracy and reducing fraud (or buildup) related to digital asset ownership transfer; (vi) ensuring the integrity of data related to a digital asset's history; (vii) saving accurate records; (viii) allowing users to interact with assets while preserving asset integrity; (ix) providing a central location for all digital assets to be stored and/or transferred; (x) providing the ability for a distributor (e.g., an executor) to securely transfer digital assets between electronic records (e.g., user accounts); (xi) providing the ability to analyze (graph, chart and/or generate other visual displays) digital assets and communicate to the owner or the beneficiaries discrepancies in assets and significant changes in value; (xii) providing an asset tracking history for all assets transferred that is securely stored for audit or other purposes; and/or (xiii) identifying all digital assets that are undistributed and enabling distribution of those undistributed assets among the parties.

The methods and systems described herein may be implemented (i) using computer programming or engineering techniques including computer software, firmware, hardware, or any combination or subset thereof, and/or (ii) by using one or more local or remote processors, transceivers, servers, sensors, servers, scanners, mobile devices, wearables, AR or VR headsets or glasses, smart glasses, and/or other electrical or electronic components, wherein the technical effects may be achieved by performing at least one of the following steps: (1) receiving a plurality of identifiers for identifying a plurality of digital assets associated with a first electronic record, each identifier of the plurality of identifiers configured to identify a digital asset and grant access to the digital asset; (2) storing the plurality of identifiers as being associated with the first electronic record; (3) receiving an input associated with at least one digital asset of the plurality of digital assets wherein the input includes a transfer identifier instruction, the transfer identifier instruction configured to cause the identifier associated with the at least one digital asset to be transferred from the first electronic record to a second electronic record; (4) identifying that a trigger condition has occurred; (5) in response to the trigger condition, executing the transfer identifier instruction to automatically cause the identifier associated with the at least one digital asset to be transferred from the first electronic record to the second electronic record based upon the transfer identifier such that the second electronic record has access rights to the digital asset; (6) receiving a plurality of digital assets associated with an electronic record of a user; (7) storing the plurality of digital assets as being associated with the electronic record; (8) receiving a request to check out at least one digital asset of the plurality of digital assets wherein the request includes an electronic target location for the at least one digital asset while the at least one digital asset is checked out; (9) causing a transfer of the at least one digital asset from the electronic record to the electronic target location; (10) recording the transfer in an electronic ledger; (11) receiving the at least one digital asset from the electronic target location; (12) storing the at least one digital asset back in the electronic record; (13) storing receipt of the at least one digital asset in the electronic ledger; (14) identifying a plurality of digital assets stored in the at least one memory for administration by a distributor; (15) identifying a plurality of potential receivers for the plurality of digital assets; (16) causing display of a plurality of selectors wherein each selector is associated with at least one digital asset of the plurality of digital assets; (17) causing display of a plurality of display areas wherein each display area is associated with at least one potential receiver of the plurality of potential receivers; (18) receiving an input associated with a selector of the plurality of selectors and a receiver of the plurality of potential receivers; (19) causing display of the selector in the display area associated with the receiver; (20) causing the at least one digital asset associated with the selector to be transferred to a digital record associated with the receiver; (21) in response to a trigger condition, automatically identifying that access to at least one identifier should be transferred from a digital record associated with a user to a different digital record associated with a different user wherein the at least one identifier is configured to identify at least one digital asset and great access to the at least one digital asset; (22) determining that no digital record has been created for the different user; (23) causing a notification to be transmitted to a user computing device associated with the different user wherein the notification includes a message indicating that the user is eligible to receive the at least one identifier; (24) in response to an input at the user computing device, creating the different digital record associated with the different user; and/or (25) causing the at least one identifier to be transferred from the digital record to the different digital record.

### Exemplary Computer Network

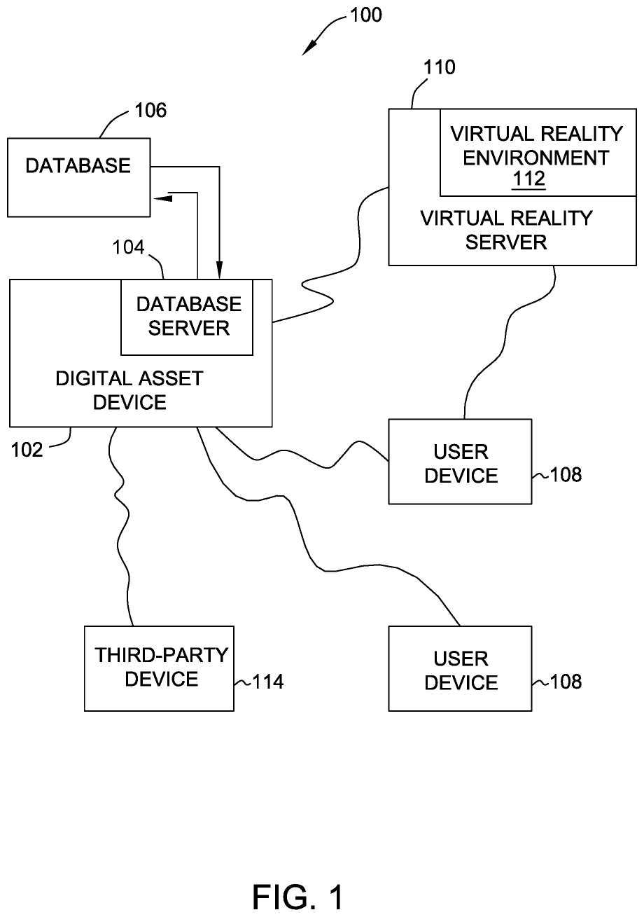

FIG. 1 illustrates an exemplary digital asset (DA) computing system 100. In the example embodiment, DA computing system 100 may be used for archiving and/or viewing digital assets.

In the exemplary embodiment, user computer devices 108 may be computers that include a web browser or a software application, which enables user computer devices 108 to access digital asset (DA) computing device 102 (e.g., and/or database 106 via database server 104) using the Internet. More specifically, user computer devices 108 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and/or a cable modem.

User computer devices 108 may be any device capable of accessing the Internet including, but not limited to, a mobile device, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), or XR (extended reality) headsets or glasses), chat bots, amd/or other web-based connectable equipment or mobile devices. In some embodiments, user computer devices 108 are capable of accessing virtual environments 112, such as through virtual reality servers 110.

Database server 104 may be communicatively coupled to database 106 that stores data. In one embodiment, database 106 may include digital assets and/or identifiers for accessing digital assets, as described herein. In the exemplary embodiment, database 106 may be stored remotely from DA device 102 and/or virtual reality server 110. In some embodiments, database 106 may be decentralized. In the example embodiment, a person may access database 106 via user computer devices 108 by logging onto DA device 102 and/or VR server 110, as described herein.

DA device 102 may be communicatively coupled with one or more user computer devices 108. In some embodiments, DA device 102 may be associated with, or is part of a computer network associated with business, or in communication with the business' computer network (not shown). In other embodiments, DA device 102 may be associated with a third party and is merely in communication with the business' computer network. In some of these embodiments, the DA device 102 is associated with (e.g., in communication with) a VR server 110.

One or more virtual reality servers 110 may be communicatively coupled with DA device 102. The one or more virtual reality servers 110 each may be associated with a virtual reality environment 112. Virtual reality servers 110 may provide tools and/or applications for users to access their associated virtual reality environments 112 over the Internet. Virtual reality environments 112 may provide immersive environments that simulates how a user receives stimuli in the real world.

In one example, virtual reality (VR) googles allow a user to see a virtual world. The VR goggles determine when the user turns their head and then renders imaging of what is where the user is looking. Further, the user may use input tools, such as controllers to interact with the environment displayed by the goggles. A user may then interact with digital objects and/or avatars that have been added to virtual reality environment 112.

In some embodiments, virtual reality environments 112 simulate parts or portions of the real-world and allow users to own and alter locations in the virtual reality environments 112. For example, a user may own a plot of virtual land and build a version of their real-world house on that plot of land. Or a business could build an office or shop to allow users to interact with the replicant persona avatars in that office or shop.

As explained herein in more detail, a DA device 102 (e.g., a DA server) may be configured to perform any of the following steps: (1) receiving a plurality of identifiers for identifying a plurality of digital assets associated with a first electronic record (e.g., account and/or ledger implemented by DA device 102), each identifier of the plurality of identifiers configured to identify a digital asset and grant access to the digital asset; (2) storing the plurality of identifiers as being associated with the first electronic record; (3) receiving an input associated with at least one digital asset of the plurality of digital assets wherein the input includes a transfer identifier instruction, the transfer identifier instruction configured to cause the identifier associated with the at least one digital asset to be transferred from the first electronic record to a second electronic record; (4) identifying that a trigger condition has occurred; (5) in response to the trigger condition, executing the transfer identifier instruction to automatically cause the identifier associated with the at least one digital asset to be transferred from the first electronic record to the second electronic record based upon the transfer identifier such that the second electronic record has access rights to the digital asset; (6) receiving a plurality of digital assets associated with an electronic record of a user; (7) storing the plurality of digital assets as being associated with the electronic record; (8) receiving a request to check out at least one digital asset of the plurality of digital assets wherein the request includes an electronic target location for the at least one digital asset while the at least one digital asset is checked out; (9) causing a transfer of the at least one digital asset from the electronic record to the electronic target location; (10) recording the transfer in an electronic ledger; (11) receiving the at least one digital asset from the electronic target location; (12) storing the at least one digital asset back in the electronic record; (13) storing receipt of the at least one digital asset in the electronic ledger; (14) identifying a plurality of digital assets stored in the at least one memory for administration by a distributor; (15) identifying a plurality of potential receivers for the plurality of digital assets; (16) causing display of a plurality of selectors wherein each selector is associated with at least one digital asset of the plurality of digital assets; (17) causing display of a plurality of display areas wherein each display area is associated with at least one potential receiver of the plurality of potential receivers; (18) receiving an input associated with a selector of the plurality of selectors and a receiver of the plurality of potential receivers; (19) causing display of the selector in the display area associated with the receiver; (20) causing the at least one digital asset associated with the selector to be transferred to a digital record associated with the receiver; (21) in response to a trigger condition, automatically identifying that access to at least one identifier should be transferred from a digital record associated with a user to a different digital record associated with a different user wherein the at least one identifier is configured to identify at least one digital asset and great access to the at least one digital asset; (22) determining that no digital record has been created for the different user; (23) causing a notification to be transmitted to a user computing device associated with the different user wherein the notification includes a message indicating that the user is eligible to receive the at least one identifier; (24) in response to an input at the user computing device, creating the different digital record associated with the different user; and/or (25) causing the at least one identifier to be transferred from the digital record to the different digital record.

### Exemplary Digital Asset Transfer Processes

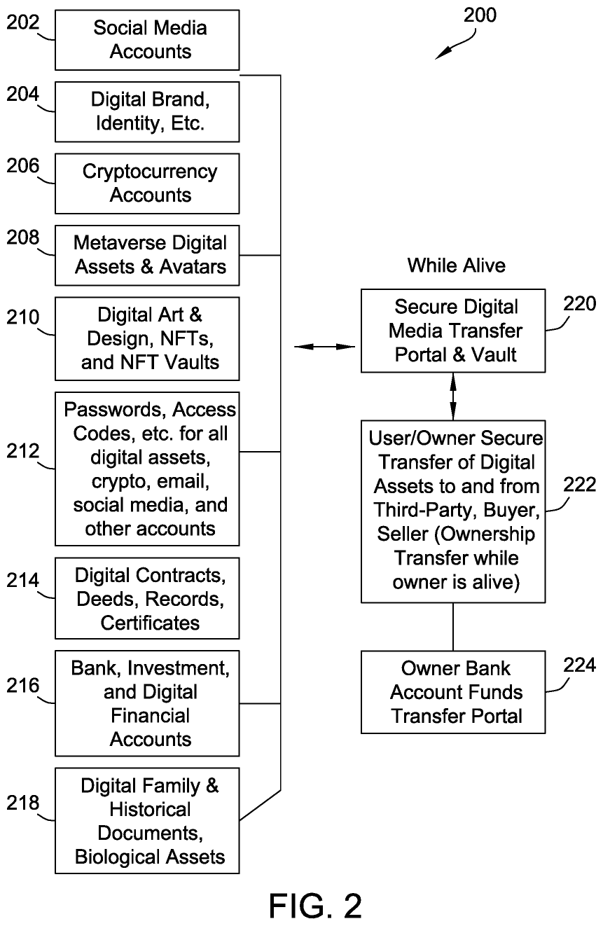

FIG. 2 illustrates an exemplary data flow diagram 200 for digital asset transfer using DA computing system 100 (e.g., while a user is alive). As shown in FIG. 2, a digital asset vault 220 and/or portal (e.g., secure digital media transfer portal and/or vault) may store digital assets associated with a user, such as social media accounts 202 (e.g., Facebook, Twitter, Instagram, and/or other places where different types of data, interactions, and/or transactions may be stored), digital brands and/or digital identities 204 (e.g., brand and/or identify associated with an avatar in the metaverse, a business, etc.), cryptocurrency accounts 206, metaverse digital assets and/or avatars 208 (e.g., digital homes, cars, skins), digital art and/or design, NFTs, and/or NFT vaults 210, passwords and/or access codes (e.g., account numbers, digital receipts, digital signatures, digital addresses, pointers, URL addresses, links, and/or other information needed to access digital assets) for all digital assets such as crypto, email, social media, and/or other accounts 212, digital contracts, digital deeds, digital records, and/or digital certificates 214 (e.g., digital “twins” of real-world assets, real-world assets themselves, and/or smart contracts), bank, investment, and/or digital financial accounts 216, and/or digital family documents, digital historical documents, and/or digital biological assets 218 (e.g., photos, home videos).

In some embodiments, digital assets may initially be transferred to vault 220 based upon user selection (e.g., an interface may be displayed to the user including a “plat” checklist, and each asset selected in the checklist is automatically imported to vault 220). In some embodiments, digital assets may be added to vault 220 by an input at a location where the digital assets are stored. For example, a user may access an account (e.g., a bank account, a social media account) hosted on a different platform, and select an icon (e.g., a displayed pop caused to be displayed by DA computing device 102) that causes the digital asset (e.g., or data for accessing the digital asset) to be stored in vault 220. As another example, voice activation may cause a digital asset to be stored in vault 220 (e.g., voice command inputted to a device by a user).

In some embodiments, verification notifications may be sent to a user device associated with a user with an account in vault 220 to notify the user of when transactions associated with digital assets in vault 220 occur. In some embodiments, a user may be able to select (e.g., at a displayed interface) a digital asset stored in vault 220 that causes the digital asset to be transferred to another platform for use (e.g., the metaverse). For example, while in the metaverse, a user may be able to select (e.g., at a displayed tray, scroll wheel, etc.) digital assets stored in DA computing system 100 for use in the metaverse. In response to selection, DA computing system 100 may transfer any selected digital assets (e.g., or duplications thereof) to the metaverse. Then, upon a subsequent input from the user (e.g., logging out of the metaverse), those digital assets may be transferred back to DA computing system 100.

As explained elsewhere herein, the user (e.g., owner) of an account may cause transfer 222 of digital assets to and/or from third parties. In other words, DA computing device 102 may handle transfer 222 of digital assets (e.g., as part of transactions) while the user is alive (e.g., and/or verify ownership rights before and/or after a transfer (e.g., based upon entries in a blockchain ledger)). In some embodiments, DA computing system 100 may further process the transfer of funds to and/or from an owner bank account 224 (e.g., or other account) as part of the transactions described herein (e.g., via one or more APIs). Updates to data stored in DA computing system 100 may also be received via one or more APIs (e.g., updates to account balances, passwords, new transactions, etc.).

In some embodiments, DA computing device 102 may execute or initialize an encryption component to encrypt asset history. More particularly, the encryption component may be configured and/or programmed to hash or otherwise encrypt the asset history to generate a file (e.g., a container file) and, thereafter, generate an entry in an electronic ledger based upon the file.

DA computing device 102 may store the file and digital assets in a cloud-based electronic ledger and/or digital/electronic record (e.g., a blockchain) for secure, immutable storage. In some embodiments, DA computing device 102 may execute or initialize a provisioning component to store the file and/or the digital asset. More specifically, the provisioning component may push or transmit files and/or digital assets to node devices that maintain the electronic ledger. The provisioning component may additionally store the files and/or digital assets on any other cloud-based storage device, such as one or more databases 232. Moreover, the provisioning component may be configured or programmed to push any updates to files and/or digital assets to node devices, in response to any updates.

DA computing device 102 may access the digital assets and associated files to perform various artificial intelligence (AI), machine learning (ML), and/or cognitive computing functions to analyze the stored data and identify, for example, behaviors, routines, risks, and past values, as well as to predict affects and/or future values based upon that stored data. In one exemplary embodiment, DA computing device 102 executes or initializes a modelling component to perform these analyses. The modelling component may be configured or programmed to train one more models and/or execute such trained models to analyze digital asset histories and output associated digital asset assessments. In some embodiments, DA computing device 102 may determine that one or more data elements are missing, where such data elements are important in the assessment of a digital asset. In such cases, DA computing device 102 may communicate with one or more data sources (e.g., user computing devices 108 and/or third-party computing devices 114) to retrieve and access such missing data.

Based upon these executed one or more AI, ML, and/or cognitive computing functions, DA computing device 102 (e.g., via a modelling component) may calculate and/or generate a digital asset assessment for the digital asset. In one or more embodiments, DA computing device 102 generates the digital asset assessment including a risk/reliability/value score and/or metric, as a quantitative assessment of the digital asset based upon reference data. DA computing device 102 may additionally generate one or more reports and/or other records associated with the digital asset and/or the digital asset assessment. DA computing device 102 may then provide the digital asset assessment and any reports/records within one or more messages to a user associated with the digital asset (e.g., a seller, buyer, executor, heir etc.), in addition to and/or alternatively from providing the digital asset itself.

In some embodiments, DA computing device 102 may update the data stored in the files and/or the digital assets. Updating may be conducted in response to a request (e.g., from a user) for a report and/or assessment, in response to receiving updated data, periodically, and/or under any other appropriate condition.

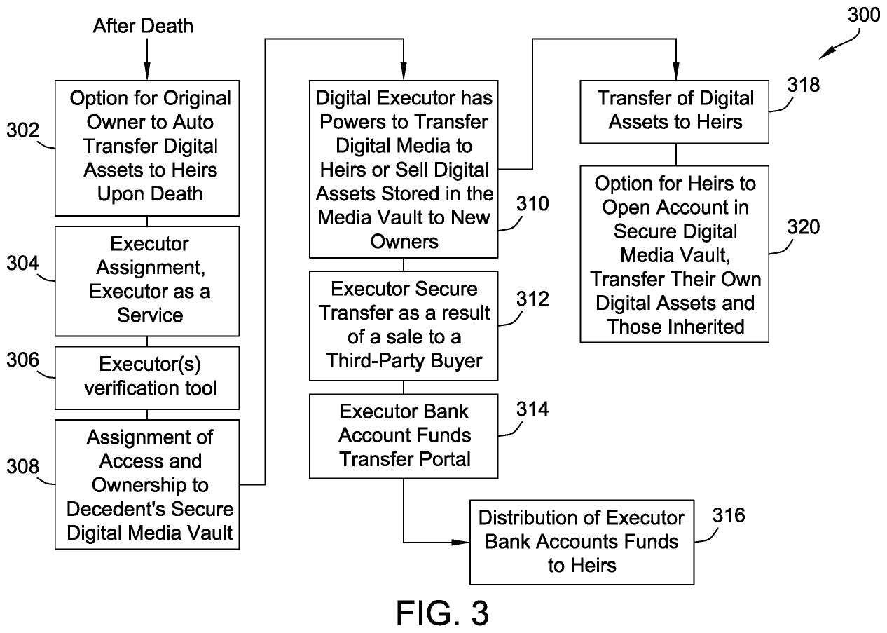

FIG. 3 illustrates another exemplary data flow diagram 300 for digital asset transfer using DA computing system 100 (e.g., when a user is deceased). As shown in FIG. 3, an owner is provided the option to have DA computing device 102 automatically transfer 302 digital assets to heirs (e.g., receivers) upon death of the owner. For example, DA computing device 102 may provide an automatic executor service 304 (e.g., controlling automatic transfer of digital assets upon death of the owner), as described herein. In some embodiments, an executor verification tool 306 may verify the identity of an executor before the executor is provided access to the owner's digital assets (e.g., the owner's account in vault 220). As examples, verification tool 306 may verify the executor identity (e.g., via one or more forms of ID, social security information, etc.), verify the decedent, and/or verify the decedent is deceased, and then DA computing device 102 may transfer those digital assets in vault 220 accordingly (e.g., to the executor).

Accordingly, DA computing device 102 may assign 308 access and/or ownership to a decedent's secure digital media vault (e.g., vault 220, digital record, and/or electronic record) to an executor. Upon transfer of access and/or ownership to the executor, the executor may transfer 310 digital media (e.g., assets) to heirs and/or sell digital assets stored in vault 220 to new owners.

In the exemplary embodiment, DA computing device 102 may control transfer of digital assets as a result of a sale 312 to a third-party buyer. Accordingly, DA computing device 102 may receive funds from a third-party buyer account at an executor bank account funds transfer portal 314 and/or distribute 316 executor bank account funds to heirs. In some embodiments, portal 314 (e.g., a central account) may allow executor to pay bills associated with an estate (e.g., funeral costs) directly from portal 314 (e.g., with transactions recorded by DA computing device 102).

In some examples, a trust or a will may call for the executor to withdraw all assets from all known accounts for placement into a single account. Such a scenario may simplify accounting by using the consolidated account to pay debts and ongoing bills, as well as final expenses. Automated processes of the DA computing device 102 may configure the single account to additionally receive any life insurance funds or other proceeds and be used to disseminate funds to heirs. The account may be set up after the primary has passed away. To facilitate such transactions, an embodiment of the DA computing system 100 may import or otherwise receive third-party contact information, authorization from all parties, and an indication of any method of preferred transfer of the digital assets.

In some embodiments, funds may be transferred from other accounts associated with a decedent (e.g., bank accounts) to portal 314 for distribution (e.g., for fees and/or distribution to heirs). In other words, a pool of funds may be generated and/or distributed from and/or to a plurality of other accounts (e.g., other accounts within DA computing system 100, third-party accounts, etc.). In some aspects, while an owner is alive, the owner may predefine and/or set aside funds (e.g., within DA computing system 100) for certain post-death expenses (e.g., funeral costs) in order for DA computing system 100 to act as automatic executor for at least a portion of digital assets associated with the owner (e.g., and placing less of a burden on an executor).

Further, DA computing device 102 may automatically transfer 318 digital assets (e.g., from vault 220) to heirs (e.g., respective vaults 220 associated with the heirs). DA computing device 102 may also provide the option 320 (e.g., by transmitting a notification to respective user devices associated with the heirs) for heirs to secure digital media in their own respective vaults 220, and/or transfer their own digital assets and/or those inherited digital assets.

In some embodiments, accounts may be generated by DA computing device 102 that are associated with other entities. For example, DA computing system 100 may store certain digital assets and only identifiers for accessing other digital assets (e.g., cryptocurrency). In some embodiments, at least for digital assets stored outside of DA computing system 100 (e.g., with identifiers stored in DA computing system 100), accounts where those digital assets are stored may be generated for a plurality of heirs. As an example, a third-party account holding cryptocurrency may be associated with a decedent. Identifiers for that account may be stored in DA computing system 100. Upon death of the decedent, DA computing system 100 may automatically cause third-party accounts to be generated for each heir designated to receive cryptocurrency, the cryptocurrency may be transferred to those new third-party accounts, and the heirs may be provided access (e.g., usernames and/or passwords) to those new accounts by DA computing system 100.

Thus, the process of transferring assets by an executor is greatly simplified based upon the functionalities implemented by DA computing system 100. For example, the executor may know, based upon data stored in DA computing system 100, which assets are “active” (e.g., currently owned by the decedent), which are “inactive” (e.g., not currently, but maybe previously, owned by the decedent), how to access those digital assets and/or the ability to transfer those digital assets.

Further, as explained herein, transfer of ownership of digital assets is securely tracked by DA computing device 102. Accordingly, the executor may have access to an official record of ownership and transfer of digital assets via DA computing system 100 rather than having to generate a manual list of transactions.

In the exemplary embodiment, DA computing device 102 may track all transfers of digital assets in DA computing system 100 and record data regarding those transfers in an electronic ledger (e.g., a blockchain ledger). As explained herein, transfers may include transactions (e.g., buying and/or selling) associated with digital assets and/or an owner accessing and/or checking in and/or out their digital assets. For example, an owner may “check out” digital clothing (e.g., see 208) for an avatar in the metaverse, DA computing device 102 may transfer that digital clothing to the metaverse environment so that the clothing appears on the avatar, and/or receive the digital clothing back from the metaverse environment and “check in” the digital clothing to vault 220 (e.g., with all transfers stored in the electronic ledger).

As another example, a user may select an avatar (e.g., in vault 220) they would like to use, and DA computing device 102 may transfer that avatar to the metaverse. Ownership of that avatar may be tracked through a ledger that shows that the user purchased the avatar from a previous owner and/or on a specific date (e.g., via a smart contract). Data stored in the ledger may be proof that the owner owns an avatar such that, when the owner no longer wants to use that avatar, the owner would be able to sell the avatar, the transaction may be recorded on the ledger again through the block chain, and/or ownership may then transfer to a different record (e.g., account) through DA computing system 100.

An implementation may use data and connections between computer devices in order to implement the transferring of digital assets into and out of the metaverse. Examples of such may include metaverse account information from the decedent and one of the heir(s). Other exchanged data may include proof of ownership of the digital assets. Other data may include proof of the receiver (e.g., authentication and validation of heirs). Communications between computer devices may include secure and encrypted transfer technologies, such as a non-fungible token (NFT).

An NFT may include a unique identifier used to certify ownership and authenticity. The transactions between the computing systems may be configured to be viewed and accessed in the metaverse for all authorized users and potential receivers. For instance, an heir may be enabled to view only what they are set to inherit.

### Exemplary User Computing Device

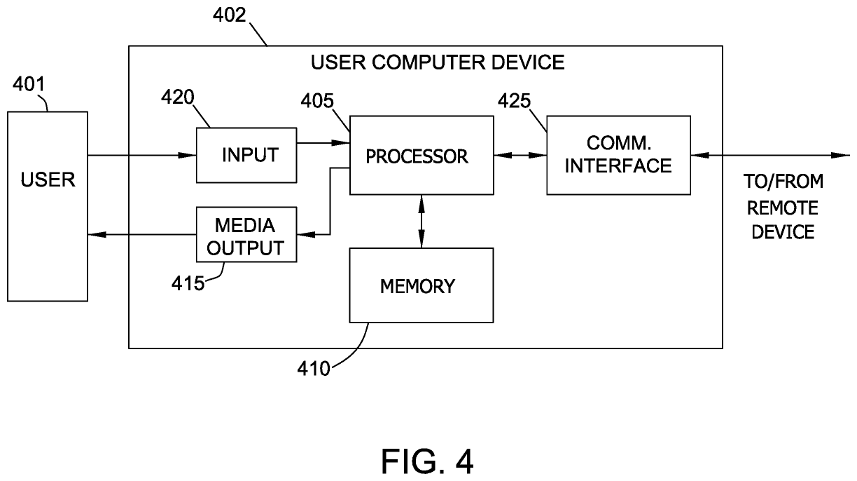

FIG. 4 depicts an exemplary configuration of a user computer device 402 that may be operated by a user 401. User computer device 402 may include, but is not limited to, third-party device 114 and/or user device 108 (shown in FIG. 1). User computer device 402 may include a processor 405 for executing instructions. In some embodiments, executable instructions are stored in a memory area 410. Processor 405 may include one or more processing units (e.g., in a multi-core configuration). Memory area 410 may be any device allowing information such as executable instructions and/or transaction data to be stored and retrieved. Memory area 410 may include one or more computer readable media.

Additionally or alternatively, user computing device 402 may be, for example, a mobile device, smart home controller, smart vehicle, smart watch, smart contact lenses, augmented reality glasses, virtual reality headset, mixed or extended reality headset or glasses, wearables, voice or chat bot, ChatGPT bot or computing device, UAV (unmanned aerial device) or drone, other input device, and/or other electronic or electrical devices.

User computer device 402 may also include at least one media output component 415 for presenting information to user 401. Media output component 415 may be any component capable of conveying information to user 401. In some embodiments, media output component 415 may include an output adapter (not shown) such as a video adapter and/or an audio adapter. An output adapter may be operatively coupled to processor 405 and operatively coupleable to an output device such as a display device (e.g., a cathode ray tube (CRT), liquid crystal display (LCD), light emitting diode (LED) display, or “electronic ink” display), an audio output device (e.g., a speaker or headphones), virtual headsets (e.g., AR (Augmented Reality), VR (Virtual Reality), or XR (extended Reality) headsets).

In some embodiments, media output component 415 may be configured to present a graphical user interface (e.g., a web browser and/or a client application) to user 401. A graphical user interface may include, for example, an interface for displaying information regarding digital assets. In some embodiments, user computer device 402 may include an input device 420 for receiving input from user 401. User 401 may use input device 420 to, without limitation, select and/or enter information regarding transfer of digital assets. Input device 420 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 415 and input device 420.

User computer device 402 may also include a communication interface 425, communicatively coupled to a remote device such as DA device 102 (shown in FIG. 1). Communication interface 425 may include, for example, a wired or wireless network adapter and/or a wireless data transceiver for use with a mobile telecommunications network.

Stored in memory area 410 are, for example, computer readable instructions for providing a user interface to user 401 via media output component 415 and, optionally, receiving and processing input from input device 420. A user interface may include, among other possibilities, a web browser and/or a client application. Web browsers enable users, such as user 401, to display and interact with media and other information typically embedded on a web page or a website from DA device 102. A client application allows user 401 to interact with, for example, DA device 102. For example, instructions may be stored by a cloud service, and the output of the execution of the instructions sent to the media output component 415.

Processor 405 executes computer-executable instructions for implementing aspects of the disclosure. In some embodiments, the processor 405 is transformed into a special purpose microprocessor by executing computer-executable instructions or by otherwise being programmed.

### Exemplary Server Device

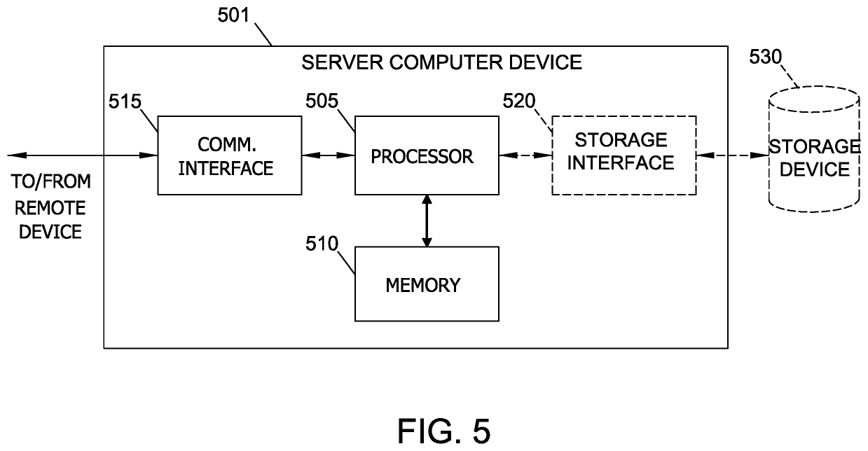

FIG. 5 depicts an exemplary configuration of server computer device 501, in accordance with one embodiment of the present disclosure. Server computer device 501 may include, but is not limited to, DA device 102 and/or VR server 110 (shown in FIG. 1). Server computer device 501 may include a processor 505 for executing instructions. Instructions may be stored in a memory area 510. Processor 505 may include one or more processing units (e.g., in a multi-core configuration).

Processor 505 may be operatively coupled to a communication interface 515 such that server computer device 501 is capable of communicating with a remote device such as another server computer device 501, third-party device 114 and/or user device 108 (shown in FIG. 1). For example, communication interface 515 may receive messages from third-party device 114 and/or user device 108 via the Internet.

Processor 505 may also be operatively coupled to a storage device 530. Storage device 530 may be any computer-operated hardware suitable for storing and/or retrieving data, such as, but not limited to, data associated with database 106 (shown in FIG. 1). In some embodiments, storage device 530 may be integrated in server computer device 501. For example, server computer device 501 may include one or more hard disk drives as storage device 530. In other embodiments, storage device 530 may be external to server computer device 501 and may be accessed by a plurality of server computer devices 501. For example, storage device 530 may include a storage area network (SAN), a network attached storage (NAS) system, and/or multiple storage units such as hard disks and/or solid state disks in a redundant array of inexpensive disks (RAID) configuration.

In some embodiments, processor 505 may be operatively coupled to storage device 530 via a storage interface 520. Storage interface 520 may be any component capable of providing processor 505 with access to storage device 530. Storage interface 520 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 505 with access to storage device 530.

Processor 505 may execute computer-executable instructions for implementing aspects of the disclosure. In some embodiments, the processor 505 may be transformed into a special purpose microprocessor by executing computer-executable instructions or by otherwise being programmed. For example, the processor 505 may be programmed with the instructions such as illustrated in FIGS. 2 and 3.

### Exemplary Digital Asset Transfer Process as Owner

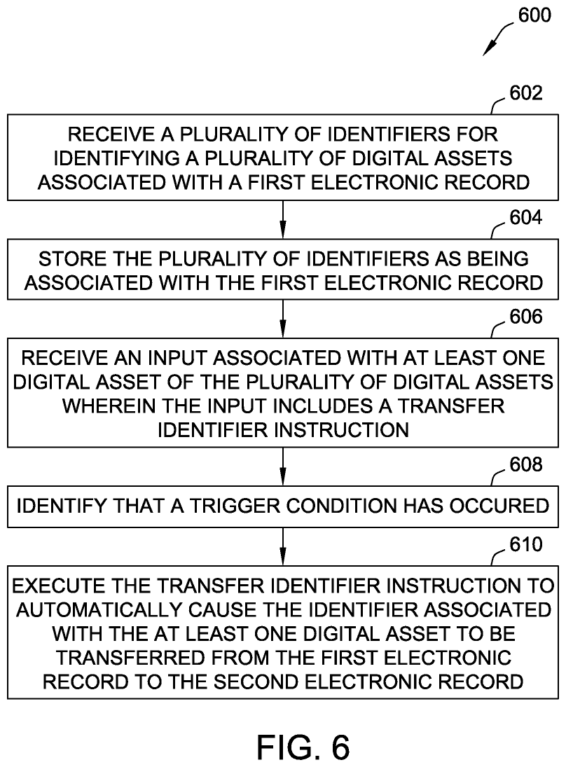

FIG. 6 illustrates an exemplary computer-implemented method 600 for digital asset transfer using DA computing system 100. For example, method 600 may relate to digital asset transfer associated with an owner (e.g., of one or more digital assets).

As shown in FIG. 6, method 600 may include receiving 602 a plurality of identifiers for identifying a plurality of digital assets associated with a first electronic record, each identifier of the plurality of identifiers configured to identify a digital asset and grant access to the digital asset. Method 600 may also include storing 604 the plurality of identifiers as being associated with the first electronic record and/or receiving 606 an input associated with at least one digital asset of the plurality of digital assets wherein the input includes a transfer identifier instruction, the transfer identifier instruction configured to cause the identifier associated with the at least one digital asset to be transferred from the first electronic record to a second electronic record.

Method 600 may further include identifying 608 that a trigger condition has occurred and/or, in response to the trigger condition and/or executing 610 the transfer identifier instruction to automatically cause the identifier associated with the at least one digital asset to be transferred from the first electronic record to the second electronic record based upon the transfer identifier such that the second electronic record has access rights to the digital asset.

In some aspects, method 600 may include in response to the trigger condition, storing identifiers associated with access to digital assets that are not associated with a respective transfer identifier as being associated with an executor account of an executor. In some aspects, method 600 may include storing at least a subset of the plurality of digital assets in the at least one memory, and wherein one or more of the plurality of identifiers includes one or more of the subset of the plurality of digital assets. In some aspects, method 600 may include receiving proof of death data regarding a user associated with the first electronic record wherein receipt of the proof of death data includes the trigger condition.

In some aspects, method 600 may include, in response to receiving the input, determining that the second electronic record has not yet been created, causing a notification to be transmitted to a user computing device associated with the second user wherein the notification includes a message prompting the second user to authorize creation of the second electronic record, in response to an authorization input at the user computing device authorizing creation of the second electronic record, creating the second electronic record associated with the second user, and/or in response to the trigger condition and verifying that the second electronic record has been created, causing the identifier associated with the at least one digital asset to be transferred from the first electronic record to the second electronic record. In some aspects, method 600 may include receiving a second input associated with another at least one digital asset wherein the another at least one digital asset was not previously associated with the second electronic record and/or causing another at least one identifier for accessing the another at least one digital asset to be stored in the second electronic record.

### Exemplary Digital Asset Transfer Process as Automatic Executor

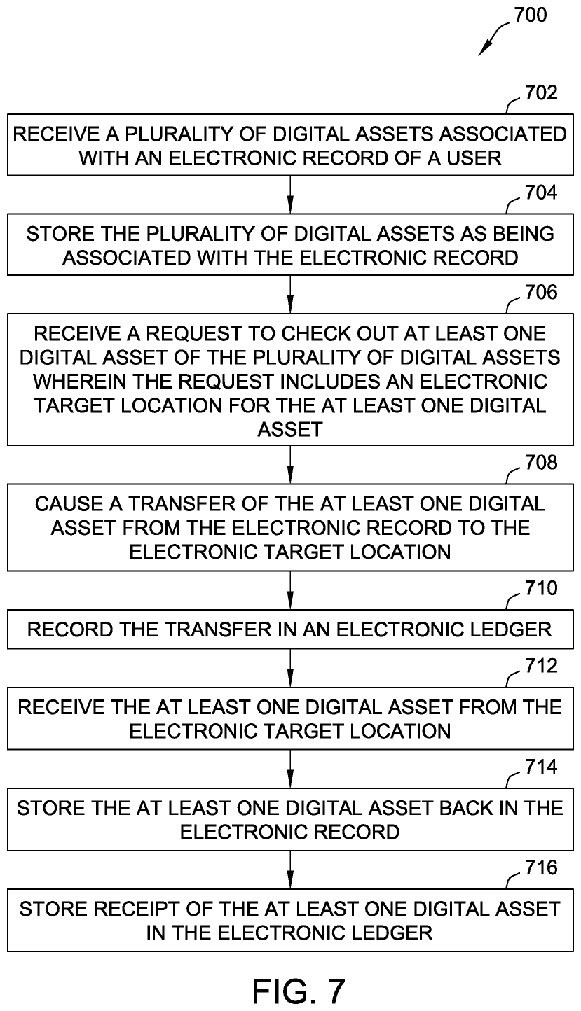

FIG. 7 illustrates another exemplary computer-implemented method 700 for digital asset transfer using DA computing system 100. For example, method 700 may relate to DA computing system 100 performing digital asset transfer as an automatic executor (e.g., executor as a service).

As shown in FIG. 7, method 700 may include receiving 702 a plurality of digital assets associated with an electronic record of a user, storing 704 the plurality of digital assets as being associated with the electronic record, and/or receiving 706 a request to check out at least one digital asset of the plurality of digital assets wherein the request includes an electronic target location for the at least one digital asset while the at least one digital asset is checked out.

Method 700 may also include causing 708 a transfer of the at least one digital asset from the electronic record to the electronic target location and/or recording 710 the transfer in an electronic ledger (e.g., a blockchain ledger). Method 700 may further include receiving 712 the at least one digital asset from the electronic target location, storing 714 the at least one digital asset back in the electronic record, and/or storing 716 receipt of the at least one digital asset in the electronic ledger.

In some aspects, method 700 may include identifying a subset of the plurality of digital assets stored in the at least one memory for administration by a distributor and/or identifying a plurality of potential receivers for the subset of digital assets.

In some aspects, method 700 may include receiving a sale input associated with a sale of a digital asset of the plurality of digital assets, causing the digital asset to be transferred to a purchaser digital record associated with a purchaser of the sale, receiving funds associated with the sale, and/or storing the funds in the plurality of digital assets for administration by the distributor.

In some aspects, method 700 may include causing display of a plurality of selectors wherein each selector is associated with at least one digital asset of the subset of digital assets, causing display of a plurality of display areas wherein each display area is associated with at least one potential receiver of the plurality of potential receivers, receiving an input associated with a selector of the plurality of selectors and a receiver of the plurality of potential receivers, causing display of the selector in the display area associated with the receiver, and/or causing the at least one digital asset associated with the selector to be transferred to a digital record associated with the receiver.

### Exemplary Digital Asset Transfer Process Including Executor Interface

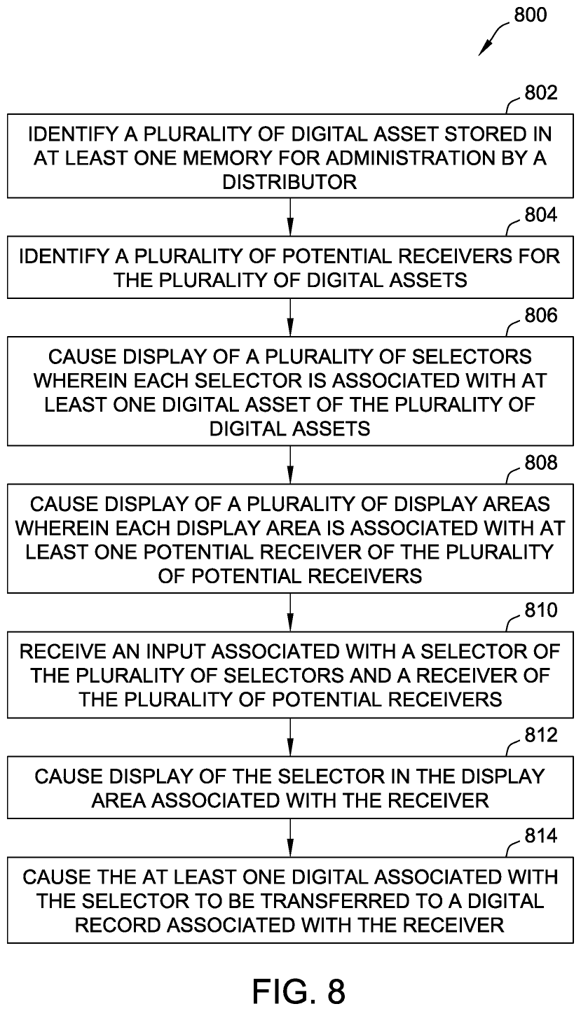

FIG. 8 illustrates another exemplary computer-implemented method 800 for digital asset transfer using DA computing system 100. For example, method 800 may relate to an executor interface provided by DA computing system 100 for digital asset transfer.

As shown in FIG. 8, method 800 may include identifying 802 a plurality of digital assets stored in the at least one memory for administration by a distributor, identifying 804 a plurality of potential receivers for the plurality of digital assets, and/or causing 806 display of a plurality of selectors wherein each selector is associated with at least one digital asset of the plurality of digital assets.

Method 800 may also include causing 808 display of a plurality of display areas wherein each display area is associated with at least one potential receiver of the plurality of potential receivers and/or receiving 810 an input associated with a selector of the plurality of selectors and a receiver of the plurality of potential receivers. Method 800 may further include causing 812 display of the selector in the display area associated with the receiver and/or causing 814 the at least one digital asset associated with the selector to be transferred to a digital record associated with the receiver.

### Exemplary Digital Asset Transfer Acceptance Process

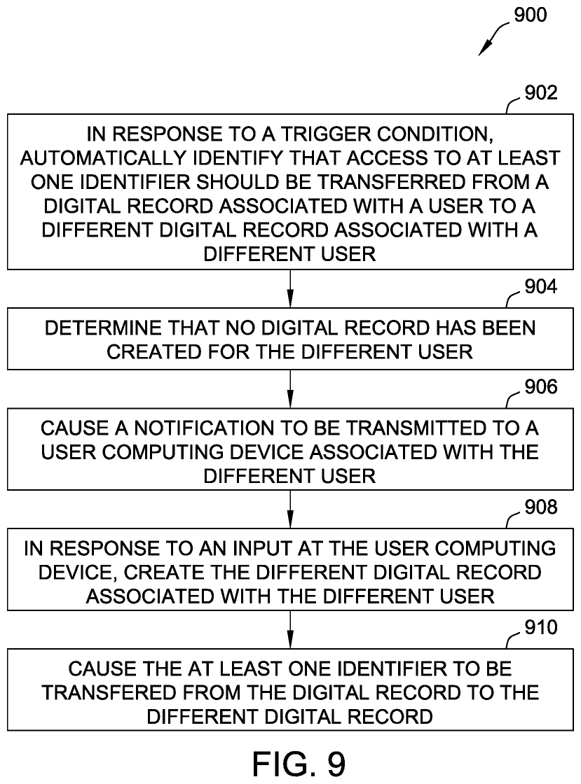

FIG. 9 illustrates another exemplary computer-implemented method 900 for digital asset transfer using DA computing system 100. For example, method 900 may relate to a digital asset acceptance process implemented by DA computing system 100.

As shown in FIG. 9, method 900 may include, in response to a trigger condition, automatically identifying 902 that access to at least one identifier should be transferred from a digital record associated with a user to a different digital record associated with a different user wherein the at least one identifier is configured to identify at least one digital asset and great access to the at least one digital asset and/or determining 904 that no digital record has been created for the different user.

Method 900 may also include causing 906 a notification to be transmitted to a user computing device associated with the different user wherein the notification includes a message indicating that the user is eligible to receive the at least one identifier and/or, in response to an input at the user computing device, creating 908 the different digital record associated with the different user. Method 900 may further include causing 910 the at least one identifier to be transferred from the digital record to the different digital record.

### Exemplary Embodiments & Functionality

In one embodiment, a DA computer system for automatically transferring digital assets may be provided. The DA computer system may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. In one instance, the DA computer system may (1) receive a plurality of identifiers for identifying a plurality of digital assets associated with a first electronic record, each identifier of the plurality of identifiers configured to identify a digital asset and grant access to the digital asset; (2) store the plurality of identifiers as being associated with the first electronic record; (3) receive an input associated with at least one digital asset of the plurality of digital assets wherein the input includes a transfer identifier instruction, the transfer identifier instruction configured to cause the identifier associated with the at least one digital asset to be transferred from the first electronic record to a second electronic record; (4) identify that a trigger condition has occurred; and/or (5) in response to the trigger condition, execute the transfer identifier instruction to automatically cause the identifier associated with the at least one digital asset to be transferred from the first electronic record to the second electronic record based upon the transfer identifier such that the second electronic record has access rights to the digital asset.

In some aspects, the at least one processor may be programmed to, in response to the trigger condition, store identifiers associated with access to digital assets that are not associated with a respective transfer identifier as being associated with an executor account of an executor.

In some aspects, the at least one processor may be programmed to store at least a subset of the digital assets in the at least one memory wherein one or more of the plurality of identifiers includes one or more of the subset of digital assets.

In some aspects, the at least one processor may be programmed to receive proof of death data regarding a user associated with the electronic record wherein receipt of the proof of death data includes the trigger condition.

In some aspects, the at least one processor may be programmed to, in response to receiving the input, determine that the second electronic record has not yet been created, cause a notification to be transmitted to a user computing device associated with the second user wherein the notification includes a message prompting the second user to authorize creation of the second electronic record, and/or in response to an authorization input at the user computing device authorizing creation of the second electronic record, create the second electronic record associated with the second user.

In some aspects, the at least one processor may be programmed to, in response to the trigger condition and verifying that the second electronic record has been created, cause the identifier associated with the at least one digital asset to be transferred from the first electronic record to the second electronic record. In some aspects, the at least one processor may be programmed to receive a second input associated with another at least one digital asset wherein the another at least one digital asset was not previously associated with the second electronic record and/or cause another at least one identifier for accessing the another at least one digital asset to be stored in the second electronic record.

In another aspect, at least one non-transitory computer-readable storage medium with instructions stored thereon may be provided. The instructions, in response to execution by at least one processor, may cause the at least one processor to: (1) receive a plurality of identifiers for identifying a plurality of digital assets associated with a first electronic record, each identifier of the plurality of identifiers configured to identify a digital asset and grant access to the digital asset; (2) store the plurality of identifiers as being associated with the first electronic record; (3) receive an input associated with at least one digital asset of the plurality of digital assets wherein the input includes a transfer identifier instruction, the transfer identifier instruction configured to cause the identifier associated with the at least one digital asset to be transferred from the first electronic record to a second electronic record; (4) identify that a trigger condition has occurred; and/or (5) in response to the trigger condition, execute the transfer identifier instruction to automatically cause the identifier associated with the at least one digital asset to be transferred from the first electronic record to the second electronic record based upon the transfer identifier such that the second electronic record has access rights to the digital asset.

In some aspects, the instructions may further cause the at least one processor to, in response to the trigger condition, store identifiers associated with access to digital assets that are not associated with a respective transfer identifier as being associated with an executor account of an executor. In some aspects, the instructions may further cause the at least one processor to store at least a subset of the plurality of digital assets in at least one memory wherein one or more of the plurality of identifiers includes one or more of the subset of the plurality of digital assets.

In some aspects, the instructions may further cause the at least one processor to receive proof of death data regarding a user associated with the first electronic record wherein receipt of the proof of death data includes the trigger condition.

In some aspects, the first electronic record may be associated with a first user and the second electronic record may be associated with a second user wherein the instructions further cause the at least one processor to, in response to receiving the input, determine that the second electronic record has not yet been created, cause a notification to be transmitted to a user computing device associated with the second user wherein the notification includes a message prompting the second user to authorize creation of the second electronic record, and/or in response to an authorization input at the user computing device authorizing creation of the second electronic record create the second electronic record associated with the second user.

In some aspects, the instructions may further cause the at least one processor to, in response to the trigger condition and verifying that the second electronic record has been created, cause the identifier associated with the at least one digital asset to be transferred from the first electronic record to the second electronic record.

In some aspects, the instructions may further cause the at least one processor to receive a second input associated with another at least one digital asset wherein the another at least one digital asset was not previously associated with the second electronic record and/or cause another at least one identifier for accessing the another at least one digital asset to be stored in the second electronic record.

In another aspect, a computer-implemented method implemented by at least one processor in communication with at least one memory may be provided. The computer-implemented method may include: (1) receiving a plurality of identifiers for identifying a plurality of digital assets associated with a first electronic record, each identifier of the plurality of identifiers configured to identify a digital asset and grant access to the digital asset; (2) storing the plurality of identifiers as being associated with the first electronic record; (3) receiving an input associated with at least one digital asset of the plurality of digital assets wherein the input includes a transfer identifier instruction, the transfer identifier instruction configured to cause the identifier associated with the at least one digital asset to be transferred from the first electronic record to a second electronic record; (4) identifying that a trigger condition has occurred; and/or (5) in response to the trigger condition, executing the transfer identifier instruction to automatically cause the identifier associated with the at least one digital asset to be transferred from the first electronic record to the second electronic record based upon the transfer identifier such that the second electronic record has access rights to the digital asset.

In some aspects, the computer-implemented method may include, in response to the trigger condition, storing identifiers associated with access to digital assets that are not associated with a respective transfer identifier as being associated with an executor account of an executor. In some aspects, the computer-implemented method may include storing at least a subset of the plurality of digital assets in the at least one memory wherein one or more of the plurality of identifiers includes one or more of the subset of the plurality of digital assets. In some aspects, the computer-implemented method may include receiving proof of death data regarding a user associated with the first electronic record, and wherein receipt of the proof of death data includes the trigger condition.

In some aspects wherein the first electronic record is associated with a first user and the second electronic record is associated with a second user, the computer-implemented method may include, in response to receiving the input, determining that the second electronic record has not yet been created, causing a notification to be transmitted to a user computing device associated with the second user wherein the notification includes a message prompting the second user to authorize creation of the second electronic record, in response to an authorization input at the user computing device authorizing creation of the second electronic record, creating the second electronic record associated with the second user, and/or in response to the trigger condition and verifying that the second electronic record has been created, causing the identifier associated with the at least one digital asset to be transferred from the first electronic record to the second electronic record.

In some aspects, the computer-implemented method may include receiving a second input associated with another at least one digital asset wherein the another at least one digital asset was not previously associated with the second electronic record and/or causing another at least one identifier for accessing the another at least one digital asset to be stored in the second electronic record.

In another aspect, a DA computing system including at least one memory and at least one processor in communication with the at least one memory may be provided. The processor may be programmed to: (1) receive a plurality of digital assets associated with an electronic record of a user; (2) store the plurality of digital assets as being associated with the electronic record; (3) receive a request to check out at least one digital asset of the plurality of digital assets wherein the request includes an electronic target location for the at least one digital asset while the at least one digital asset is checked out; (4) cause a transfer of the at least one digital asset from the electronic record to the electronic target location; (5) record the transfer in an electronic ledger; (6) receive the at least one digital asset from the electronic target location; (7) store the at least one digital asset back in the electronic record; and/or (8) store receipt of the at least one digital asset in the electronic ledger.

In some aspects, the electronic ledger may include a blockchain ledger. In some aspects, the at least one processor may be further programmed to identify a subset of the plurality of digital assets stored in the at least one memory for administration by a distributor and/or identify a plurality of potential receivers for the subset of digital assets.

In some aspects, the at least one processor may be further programmed to receive a sale input associated with a sale of a digital asset of the plurality of digital assets and/or cause the digital asset to be transferred to a purchaser digital record associated with a purchaser of the sale. In some aspects, the at least one processor may be further programmed to receive funds associated with the sale and/or store the funds in the plurality of digital assets for administration by the distributor.

In some aspects, the at least one processor may be further programmed to cause display of a plurality of selectors wherein each selector is associated with at least one digital asset of the subset of digital assets and/or cause display of a plurality of display areas wherein each display area is associated with at least one potential receiver of the plurality of potential receivers. In some aspects, the at least one processor may be further programmed to receive an input associated with a selector of the plurality of selectors and a receiver of the plurality of potential receivers and/or cause display of the selector in the display area associated with the receiver. In some aspects, the at least one processor may be further programmed to cause the at least one digital asset associated with the selector to be transferred to a digital record associated with the receiver.

In another aspect, at least one non-transitory computer-readable storage medium with instructions stored thereon may be provided. The instructions, in response to execution by at least one processor, may cause the at least one processor to: (1) receive a plurality of digital assets associated with an electronic record of a user; (2) store the plurality of digital assets as being associated with the electronic record; (3) receive a request to check out at least one digital asset of the plurality of digital assets wherein the request includes an electronic target location for the at least one digital asset while the at least one digital asset is checked out; (4) cause a transfer of the at least one digital asset from the electronic record to the electronic target location; (5) record the transfer in an electronic ledger; (6) receive the at least one digital asset from the electronic target location; (7) store the at least one digital asset back in the electronic record; and/or (8) store receipt of the at least one digital asset in the electronic ledger.

In some aspects, the electronic ledger may include a blockchain ledger. In some aspects, the instructions may further cause the at least one processor to identify a subset of the plurality of digital assets stored in the at least one memory for administration by a distributor and/or identify a plurality of potential receivers for the subset of digital assets.

In some aspects, the instructions may further cause the at least one processor to receive a sale input associated with a sale of a digital asset of the plurality of digital assets and/or cause the digital asset to be transferred to a purchaser digital record associated with a purchaser of the sale. In some aspects, the instructions may further cause the at least one processor to receive funds associated with the sale and/or store the funds in the plurality of digital assets for administration by the distributor.

In some aspects, the instructions may further cause the at least one processor to cause display of a plurality of selectors wherein each selector is associated with at least one digital asset of the subset of digital assets and/or cause display of a plurality of display areas wherein each display area is associated with at least one potential receiver of the plurality of potential receivers. In some aspects, the instructions may further cause the at least one processor to receive an input associated with a selector of the plurality of selectors and a receiver of the plurality of potential receivers and/or cause display of the selector in the display area associated with the receiver. In some aspects, the instructions may further cause the at least one processor to cause the at least one digital asset associated with the selector to be transferred to a digital record associated with the receiver.

In another aspect, a computer-implemented method implemented by at least one processor in communication with at least one memory may be provided. The computer-implemented method may include: (1) receiving a plurality of digital assets associated with an electronic record of a user; (2) storing the plurality of digital assets as being associated with the electronic record; (3) receiving a request to check out at least one digital asset of the plurality of digital assets wherein the request includes an electronic target location for the at least one digital asset while the at least one digital asset is checked out; (4) causing a transfer of the at least one digital asset from the electronic record to the electronic target location; (5) recording the transfer in an electronic ledger; (6) receiving the at least one digital asset from the electronic target location; (7) storing the at least one digital asset back in the electronic record; and/or (8) storing receipt of the at least one digital asset in the electronic ledger.

In some aspects, the computer-implemented method may further include identifying a subset of the plurality of digital assets stored in the at least one memory for administration by a distributor and/or identifying a plurality of potential receivers for the subset of digital assets.

In some aspects, the computer-implemented method may further include receiving a sale input associated with a sale of a digital asset of the plurality of digital assets, causing the digital asset to be transferred to a purchaser digital record associated with a purchaser of the sale, receiving funds associated with the sale, and/or storing the funds in the plurality of digital assets for administration by the distributor.

In some aspects, the computer-implemented method may further include causing display of a plurality of selectors wherein each selector is associated with at least one digital asset of the subset of digital assets, causing display of a plurality of display areas wherein each display area is associated with at least one potential receiver of the plurality of potential receivers, receiving an input associated with a selector of the plurality of selectors and a receiver of the plurality of potential receivers, causing display of the selector in the display area associated with the receiver, and/or causing the at least one digital asset associated with the selector to be transferred to a digital record associated with the receiver.

In another aspect, a DA computing system including at least one memory and at least one processor in communication with the at least one memory may be provided. The processor may be programmed to: (1) identify a plurality of digital assets stored in the at least one memory for administration by a distributor; (2) identify a plurality of potential receivers for the plurality of digital assets; (3) cause display of a plurality of selectors wherein each selector is associated with at least one digital asset of the plurality of digital assets; (4) cause display of a plurality of display areas wherein each display area is associated with at least one potential receiver of the plurality of potential receivers; (5) receive an input associated with a selector of the plurality of selectors and a receiver of the plurality of potential receivers; (6) cause display of the selector in the display area associated with the receiver; and/or (7) cause the at least one digital asset associated with the selector to be transferred to a digital record associated with the receiver.

In some aspects, the at least one processor may be programmed to receive a sale input associated with a sale of a digital asset of the plurality of digital assets, cause the digital asset to be transferred to a purchaser digital record associated with a purchaser of the sale, receive funds associated with the sale, and/or store the funds in the plurality of digital assets for administration by the distributor.

In another aspect, a computer-implemented method implemented by at least one processor in communication with at least one memory may be provided. The computer-implemented method may include: (1) identifying a plurality of digital assets stored in the at least one memory for administration by a distributor; (2) identifying a plurality of potential receivers for the plurality of digital assets; (3) causing display of a plurality of selectors wherein each selector is associated with at least one digital asset of the plurality of digital assets; (4) causing display of a plurality of display areas wherein each display area is associated with at least one potential receiver of the plurality of potential receivers; (5) receiving an input associated with a selector of the plurality of selectors and a receiver of the plurality of potential receivers; (6) causing display of the selector in the display area associated with the receiver; and/or (7) causing the at least one digital asset associated with the selector to be transferred to a digital record associated with the receiver.

In another aspect, a DA computing system including at least one memory and at least one processor in communication with the at least one memory may be provided. The processor may be programmed to: (1) in response to a trigger condition, automatically identify that access to at least one identifier should be transferred from a digital record associated with a user to a different digital record associated with a different user wherein the at least one identifier is configured to identify at least one digital asset and great access to the at least one digital asset; (2) determine that no digital record has been created for the different user in the DA computing system; (3) cause a notification to be transmitted to a user computing device associated with the different user wherein the notification includes a message indicating that the user is eligible to receive the at least one identifier; (4) in response to an input at the user computing device, create the different digital record associated with the different user; and/or (5) cause the at least one identifier to be transferred from the digital record to the different digital record.

In some aspects, the at least one processor may be programmed to receive a second input associated with another at least one digital asset, wherein the another at least one digital asset was not previously associated with the digital record and/or cause another at least one identifier for accessing the another at least one digital asset to be stored in the different digital record.

In another aspect, a computer-implemented method implemented by at least one processor in communication with at least one memory may be provided. The computer-implemented method may include: (1) in response to a trigger condition, automatically identifying that access to at least one identifier should be transferred from a digital record associated with a user to a different digital record associated with a different user wherein the at least one identifier is configured to identify at least one digital asset and great access to the at least one digital asset; (2) determining that no digital record has been created for the different user; (3) causing a notification to be transmitted to a user computing device associated with the different user wherein the notification includes a message indicating that the user is eligible to receive the at least one identifier; (4) in response to an input at the user computing device, creating the different digital record associated with the different user; and/or (5) causing the at least one identifier to be transferred from the digital record to the different digital record.

### Machine Learning & Other Matters

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on vehicles or mobile devices, in homes, as part of an “internet of things” architecture, or otherwise associated with smart infrastructure or remote servers), voice or chat bots, ChatGPT bots, augmented reality glasses, virtual reality headsets, mixed or extended reality headsets or glasses, mobile devices, smart watches, wearables, smart contact lenses, other computing input devices, and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and may be followed with reinforcement or reinforced learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs. The machine learning programs may utilize deep learning algorithms that may be primarily focused on pattern recognition and may be trained after processing multiple examples. The machine learning programs may include Bayesian program learning (BPL), voice recognition and synthesis, image or object recognition, optical character recognition, and/or natural language processing-either individually or in combination. The machine learning programs may also include natural language processing, semantic analysis, automatic reasoning, and/or machine learning.

In supervised machine learning, a processing element may be provided with example inputs and their associated outputs and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, e.g., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor and can be implemented in a high-level procedural and/or object-oriented programming language, and/or in assembly/machine language. As used herein, the terms “machine-readable medium” and/or “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are examples only and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and/or any other structured or unstructured collection of records or data that is stored in a computer system. The above examples are not intended to limit in any way the definition and/or meaning of the term database. Examples of RDBMS's include, but are not limited to, Oracle® Database, MySQL, IBM® DB2, Microsoft® SQL Server, Sybase®, and/or PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, the terms “software” and “firmware” are interchangeable and include any computer program stored in memory for execution by a processor, including RAM memory, ROM memory, EPROM memory, EEPROM memory, and/or non-volatile RAM (NVRAM) memory. The above memory types are example only and are thus not limiting as to the types of memory usable for storage of a computer program.

In another embodiment, a computer program may be provided, and the program may be embodied on a computer-readable medium. In an exemplary embodiment, the system may be executed on a single computer system, without requiring a connection to a server computer. In a further example embodiment, the system may be being run in a Windows® environment (Windows is a registered trademark of Microsoft Corporation, Redmond, Washington). In yet another embodiment, the system may be run on a mainframe environment and a UNIX® server environment (UNIX is a registered trademark of X/Open Company Limited located in Reading, Berkshire, United Kingdom). In a further embodiment, the system may be run on an iOS® environment (iOS is a registered trademark of Cisco Systems, Inc. located in San Jose, CA). In yet a further embodiment, the system may be run on a Mac OS® environment (Mac OS is a registered trademark of Apple Inc. located in Cupertino, CA). In still yet a further embodiment, the system may be run on Android® OS (Android is a registered trademark of Google, Inc. of Mountain View, CA). In another embodiment, the system may be run on Linux® OS (Linux is a registered trademark of Linus Torvalds of Boston, MA). The application may be flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process may be practiced independent and separate from other components and processes described herein. Each component and process may also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Further, references to “exemplary embodiment” or “one embodiment” of the present disclosure are not intended to be interpreted as excluding the existence of additional embodiments that also incorporate the recited features.

Disjunctive language such as the phrase “at least one of X, Y, or Z,” unless specifically stated otherwise, is generally understood within the context as used to state that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A digital asset (DA) computing system comprising at least one processor in communication with at least one memory, wherein the at least one processor is programmed to:
receive a plurality of digital assets associated with an electronic record of a user;
store the plurality of digital assets as being associated with the electronic record;
receive a request to check out at least one digital asset of the plurality of digital assets, wherein the request comprises an electronic target location for the at least one digital asset while the at least one digital asset is checked out;
cause a transfer of the at least one digital asset from the electronic record to the electronic target location;
record the transfer in an electronic ledger;
receive the at least one digital asset from the electronic target location;
store the at least one digital asset back in the electronic record; and
store receipt of the at least one digital asset in the electronic ledger.

2. The DA computing system of claim 1, wherein the electronic ledger comprises a blockchain ledger.

3. The DA computing system of claim 1, wherein the at least one processor is further programmed to:
identify a subset of the plurality of digital assets stored in the at least one memory for administration by a distributor; and
identify a plurality of potential receivers for the subset of digital assets.

4. The DA computing system of claim 3, wherein the at least one processor is further programmed to:
receive a sale input associated with a sale of a digital asset of the plurality of digital assets; and
cause the digital asset to be transferred to a purchaser digital record associated with a purchaser of the sale.

5. The DA computing system of claim 4, wherein the at least one processor is further programmed to:
receive funds associated with the sale; and
store the funds in the plurality of digital assets for administration by the distributor.

6. The DA computing system of claim 3, wherein the at least one processor is further programmed to:
cause display of a plurality of selectors, wherein each selector is associated with at least one digital asset of the subset of digital assets; and
cause display of a plurality of display areas, wherein each display area is associated with at least one potential receiver of the plurality of potential receivers.

7. The DA computing system of claim 6, wherein the at least one processor is further programmed to:
receive an input associated with a selector of the plurality of selectors and a receiver of the plurality of potential receivers; and
cause display of the selector in the display area associated with the receiver.

8. The DA computing system of claim 7, wherein the at least one processor is further programmed to cause the at least one digital asset associated with the selector to be transferred to a digital record associated with the receiver.

9. At least one non-transitory computer-readable storage medium with instructions stored thereon that, in response to execution by at least one processor, cause the at least one processor to:
receive a plurality of digital assets associated with an electronic record of a user;
store the plurality of digital assets as being associated with the electronic record;
receive a request to check out at least one digital asset of the plurality of digital assets, wherein the request comprises an electronic target location for the at least one digital asset while the at least one digital asset is checked out;
cause a transfer of the at least one digital asset from the electronic record to the electronic target location;
record the transfer in an electronic ledger;
receive the at least one digital asset from the electronic target location;
store the at least one digital asset back in the electronic record; and
store receipt of the at least one digital asset in the electronic ledger.

10. The at least one non-transitory computer-readable storage medium of claim 9, wherein the electronic ledger comprises a blockchain ledger.

11. The at least one non-transitory computer-readable storage medium of claim 9, wherein the instructions further cause the at least one processor to:
identify a subset of the plurality of digital assets stored in at least one memory for administration by a distributor; and
identify a plurality of potential receivers for the subset of digital assets.

12. The at least one non-transitory computer-readable storage medium of claim 11, wherein the instructions further cause the at least one processor to:
receive a sale input associated with a sale of a digital asset of the plurality of digital assets; and
cause the digital asset to be transferred to a purchaser digital record associated with a purchaser of the sale.

13. The at least one non-transitory computer-readable storage medium of claim 12, wherein the instructions further cause the at least one processor to:
receive funds associated with the sale; and
store the funds in the plurality of digital assets for administration by the distributor.

14. The at least one non-transitory computer-readable storage medium of claim 12, wherein the instructions further cause the at least one processor to:
cause display of a plurality of selectors, wherein each selector is associated with at least one digital asset of the subset of digital assets; and
cause display of a plurality of display areas, wherein each display area is associated with at least one potential receiver of the plurality of potential receivers.

15. The at least one non-transitory computer-readable storage medium of claim 14, wherein the instructions further cause the at least one processor to:
receive an input associated with a selector of the plurality of selectors and a receiver of the plurality of potential receivers; and
cause display of the selector in the display area associated with the receiver.

16. The at least one non-transitory computer-readable storage medium of claim 15, wherein the instructions further cause the at least one processor to cause the at least one digital asset associated with the selector to be transferred to a digital record associated with the receiver.

17. A computer-implemented method implemented by at least one processor in communication with at least one memory, the computer-implemented method comprising:
receiving a plurality of digital assets associated with an electronic record of a user;
storing the plurality of digital assets as being associated with the electronic record;
receiving a request to check out at least one digital asset of the plurality of digital assets, wherein the request comprises an electronic target location for the at least one digital asset while the at least one digital asset is checked out;
causing a transfer of the at least one digital asset from the electronic record to the electronic target location;
recording the transfer in an electronic ledger;
receiving the at least one digital asset from the electronic target location;
storing the at least one digital asset back in the electronic record; and
storing receipt of the at least one digital asset in the electronic ledger.

18. The computer-implemented method implemented of claim 17, further comprising:
identifying a subset of the plurality of digital assets stored in the at least one memory for administration by a distributor; and
identifying a plurality of potential receivers for the subset of digital assets.

19. The computer-implemented method implemented of claim 18, further comprising:
receiving a sale input associated with a sale of a digital asset of the plurality of digital assets;
causing the digital asset to be transferred to a purchaser digital record associated with a purchaser of the sale;
receiving funds associated with the sale; and
storing the funds in the plurality of digital assets for administration by the distributor.

20. The computer-implemented method implemented of claim 18, further comprising:
causing display of a plurality of selectors, wherein each selector is associated with at least one digital asset of the subset of digital assets;
causing display of a plurality of display areas, wherein each display area is associated with at least one potential receiver of the plurality of potential receivers;
receiving an input associated with a selector of the plurality of selectors and a receiver of the plurality of potential receivers;
causing display of the selector in the display area associated with the receiver; and
causing the at least one digital asset associated with the selector to be transferred to a digital record associated with the receiver.
